(19) United States
(12) Patent Application Publication
(10) Pub. No.: US 2016/0196522 A1
(43) Pub. Date: Jul. 7, 2016

(54) PULSED-SURVEY SERVICE SYSTEMS AND METHODS

(71) Applicant: TINYHR INC., Seattle, WA (US)

(72) Inventors: David NIU, Seattle, WA (US); David HAJDU, Ho Chi Minh City (VN)

(21) Appl. No.: 14/987,560

(22) Filed: Jan. 4, 2016

Related U.S. Application Data
(63) Continuation-in-part of application No. 14/030,924, filed on Sep. 18, 2013, now abandoned.
(60) Provisional application No. 61/720,340, filed on Oct. 30, 2012.

(51) Int. Cl. G06Q 10/06

(52) U.S. Cl. CPC G06Q 10/06393

(57) ABSTRACT

A pulsed-survey service may be provided by obtaining a question sequence including a number of survey questions, and determining a base survey-pulse rate, such as once per week, but no more frequent than once per day. During each pulse period, for each of a number of subscriber entities, a pulsed survey is performed. Each survey pulse poses and collects responses for at least one, but no more than ten percent of the survey questions. Both intra- and inter-entity benchmark statistics are determined for the pulsed-survey responses, and the statistics and survey results are provided for presentation to the subscriber entity via a survey-results interface.

### CROSS-REFERENCE TO RELATED APPLICATIONS

This application is a Continuation in Part of U.S. patent application Ser. No. 14/030,924, filed Sep. 18, 2013, under Attorney Docket No. TINH-2012004; titled PULSED EMPLOYEE-SURVEYS SYSTEMS AND METHODS; and naming inventor David NIU. U.S. patent application Ser. No. 14/030,924 claims the benefit of priority to Provisional Patent Application No. 61/720,340; filed Oct. 30, 2012 under Attorney Docket No. TINH-2012002; titled PULSED EMPLOYEE-SURVEYS SYSTEMS AND METHODS; and naming inventor David NIU. The above-cited applications are hereby incorporated by reference, in their entirety, for all purposes.

### FIELD

This disclosure is directed to the field of computer-mediated surveys, and more particularly, to automatically surveying business employees and other survey recipients on a periodic basis.

### BACKGROUND

Human resource management (“HRM”) refers to the management of an organization's workforce, or human resources. HRM is responsible for attracting, selecting, retaining, assessing, and/or rewarding employees, as well as overseeing organizational leadership and culture, and ensuring compliance with employment and labor laws.

Many large organizations have dedicated HRM personnel, whose job functions include monitoring employee sentiment and managing employee retention, all of which can contribute to maintaining a healthy and happy “culture” of a given organization. By contrast, many small- and medium-sized businesses lack dedicated HRM personnel. Frequently, the CEO or another manager may play multiple roles while running the company, including taking out the trash, ordering pizza, and acting as a one-person HRM department when necessary.

However, cultivating a healthy and happy company culture, maintaining employee satisfaction, and managing employee retention are at least as important in small- and medium-sized businesses as they are in larger organizations. Nonetheless, small- and medium-sized business managers may lack lightweight, frictionless, and easy-to-use solutions for monitoring and managing employee satisfaction, engagement, retention, and alignment with company values.

Similarly, many small- and medium-sized businesses may wish to use similar solutions for monitoring and managing satisfaction, engagement, retention, and alignment with company values among clients, customers, and/or other non-employees.

### BRIEF DESCRIPTION OF THE DRAWINGS

FIG. 1 illustrates a simplified pulsed survey system in which pulsed-survey server, Manager Device, Respondent Devices, and Client Entity B Device are connected to network.

FIG. 2 illustrates several components of an exemplary pulsed-survey server in accordance with one embodiment.

FIG. 3 illustrates a routine for providing a pulsed-survey service, such as may be performed by a pulsed-survey server in accordance with one embodiment.

FIG. 4 illustrates a subroutine for performing a survey pulse for a given client entity during a given pulse period from a given survey question set/sequence and an optional persistent survey question set, such as may be performed by a pulsed-survey server in accordance with one embodiment.

FIG. 5 illustrates a subroutine for obtaining pulsed-survey responses for a given survey question group for a given client entity during a given pulse period, such as may be performed by a pulsed-survey server in accordance with one embodiment.

FIG. 6 illustrates a subroutine for providing a survey-results interface for a given client entity and a given pulse period, such as may be performed by a pulsed-survey server in accordance with one embodiment.

FIG. 7 illustrates a subroutine for providing a results display for a given quantitative survey question and a given client entity, such as may be performed by a pulsed-survey server in accordance with one embodiment.

FIG. 8 illustrates a subroutine for providing a results display for a non-quantitative survey question, such as may be performed by a pulsed-survey server in accordance with one embodiment.

FIG. 9 illustrates an exemplary pulsed-survey interface posing survey questions to a respondent, in accordance with one embodiment.

FIG. 10 illustrates an exemplary survey-responses dashboard interface, in accordance with one embodiment.

FIG. 11 illustrates an exemplary anonymized-communication interface enabling anonymized communication with a given respondent who provided a non-attributed, non-quantitative response to a given survey question, in accordance with one embodiment.

FIG. 12 illustrates a generic organizational chart for an organization.

FIG. 13 illustrates a goal alignment tracking system in accordance with various embodiments.

FIG. 14 illustrates several components of an exemplary goal alignment tracking server in accordance with various embodiments.

FIG. 15 illustrates an exemplary organizational-level goal definition routine in accordance with various embodiments.

FIG. 16 illustrates an exemplary individual-level goal definition routine in accordance with various embodiments.

FIG. 17 illustrates an exemplary individual-level goal monitoring routine accordance with various embodiments.

FIG. 18 illustrates an exemplary goal progress assessment notification sub-routine in accordance with various embodiments.

FIG. 19 illustrates an exemplary goal progress assessment update routine in accordance with various embodiments.

FIG. 20 illustrates an exemplary cumulative goal progress assessment sub-routine in accordance with various embodiments.

FIG. 21 illustrates an exemplary related-goal update sub-routine in accordance with various embodiments.

FIG. 22 illustrates an exemplary assessment misalignment notification sub-routine in accordance with various embodiments.

FIG. 23 illustrates an exemplary goal progress review sub-routine of the subject matter in accordance with various embodiments.

FIG. 24 illustrates an exemplary cumulative actor goal progress assessment routine in accordance with various embodiments.

### DESCRIPTION

In various embodiments as described herein, various techniques may be employed to pose survey questions to employees, clients, and/or customers of multiple business entities in a “pulsed” manner, such that over time, an evolving picture of survey-recipient sentiment and happiness with respect to a business entity may be collected without unduly imposing on employees at any one point in time.

In one commercial embodiment, a CEO or other manager may sign up for a pulsed-survey service and invite the company's employees, clients, and/or customers to participate. At a “base” pulse-rate (e.g., once per week), the survey recipients are asked to anonymously answer a handful of sentiment questions collectively designed to elicit responses indicating their sentiments with respect to the business entity. For example, when the survey recipients are employees of a business entity, sentiment questions may elicit responses indicating how happy they are; whether they can articulate the company's vision, mission, and cultural values; how valued they feel; what they like and dislike about their jobs; areas where they see room for improvement; and other such sentiments.

Generally, sentiment questions are posed only once or are repeated only infrequently and/or not on a fixed cycle. However, in one commercial embodiment, one or a small number of questions may be repeated on a periodic sub-cycle (e.g., once per month or every other week, if the “base” pulse rate is once per week). For example, when the survey recipients are employees of a business entity, a sub-cyclic question asks the employees how happy they are, such that happiness trends can be observed over time in a given company. Similarly, if the survey recipients are outside the business entity (e.g., they are clients, customers, or the like), a sub-cyclic question may ask the recipients how happy they are with the goods and/or services provided by the business entity.

Additionally, in one embodiment, the survey-recipients can highlight co-workers and/or employees of the business entity for anonymous or attributed praise and/or provide anonymous suggestions to management.

Additional details, embodiments, and alternatives are described below.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

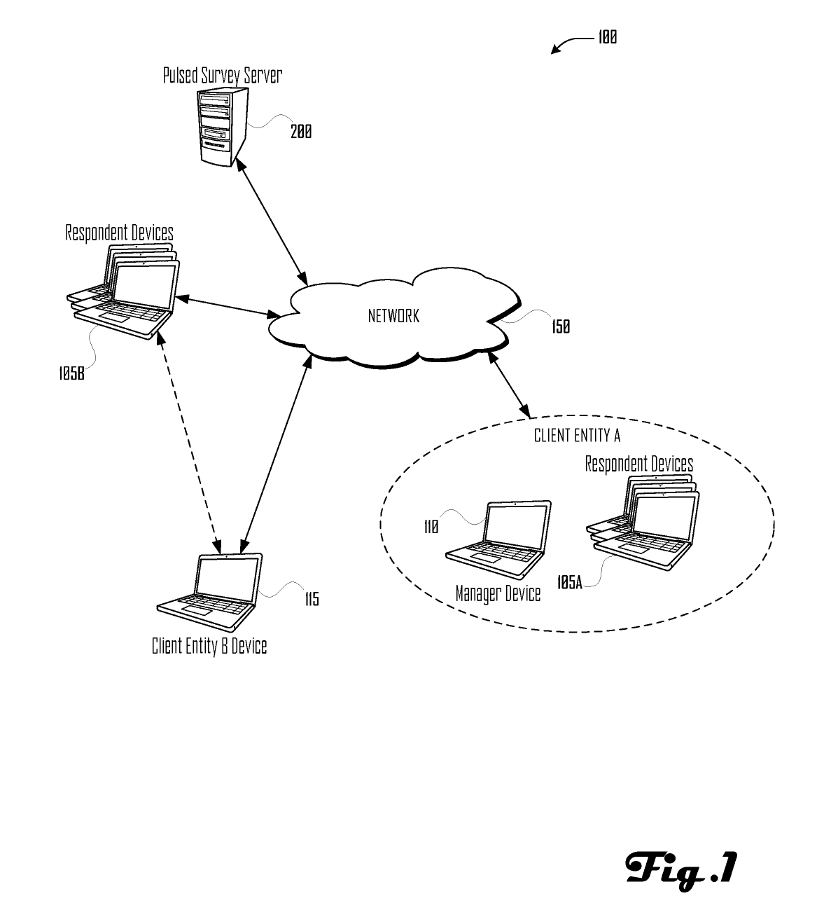

FIG. 1 illustrates a simplified pulsed survey system in which pulsed-survey server 200, Manager Device 110, Respondent Devices 105A-B, and Client Entity B Device 115 are connected to network 150.

In various embodiments, network 150 may include the Internet, a local area network (“LAN”), a wide area network (“WAN”), and/or other data network.

In various embodiments, manager, client, and respondent devices may include desktop PCs, mobile phones, laptops, tablets, or other computing devices that are capable of connecting to network 150 and consuming services such as those described herein.

In many embodiments, additional business entities may be represented within the system, and each business entity may include more employee, respondent, and/or manager devices than are displayed in FIG. 1.

In various embodiments, additional infrastructure (e.g., cell sites, routers, gateways, firewalls, and the like), as well as additional devices may be present. Further, in some embodiments, the functions described as being provided by some or all of pulsed-survey server 200 may be implemented via various combinations of physical and/or logical devices. However, it is not necessary to show such infrastructure and implementation details in FIG. 1 in order to describe an illustrative embodiment.

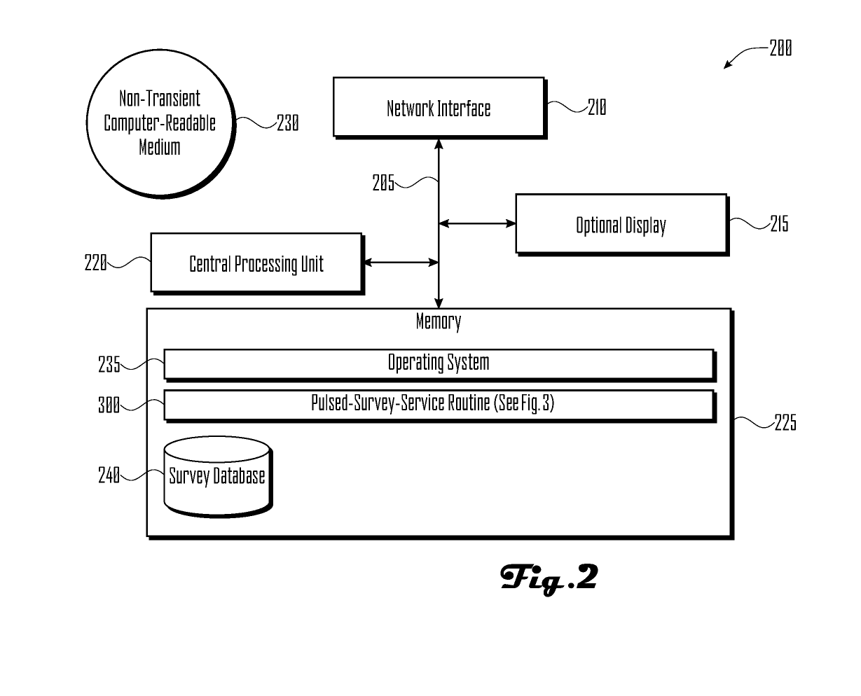

FIG. 2 illustrates several components of an exemplary pulsed-survey server in accordance with one embodiment. In some embodiments, pulsed-survey server 200 may include many more components than those shown in FIG. 2. However, it is not necessary that all of these generally conventional components be shown in order to disclose an illustrative embodiment.

In various embodiments, pulsed-survey server 200 may comprise one or more physical and/or logical devices that collectively provide the functionalities described herein. In some embodiments, pulsed-survey server 200 may comprise one or more replicated and/or distributed physical or logical devices.

In some embodiments, pulsed-survey server 200 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Pulsed-survey server 200 includes a bus 205 interconnecting several components including a network interface 210, an optional display 215, a central processing unit 220, and a memory 225.

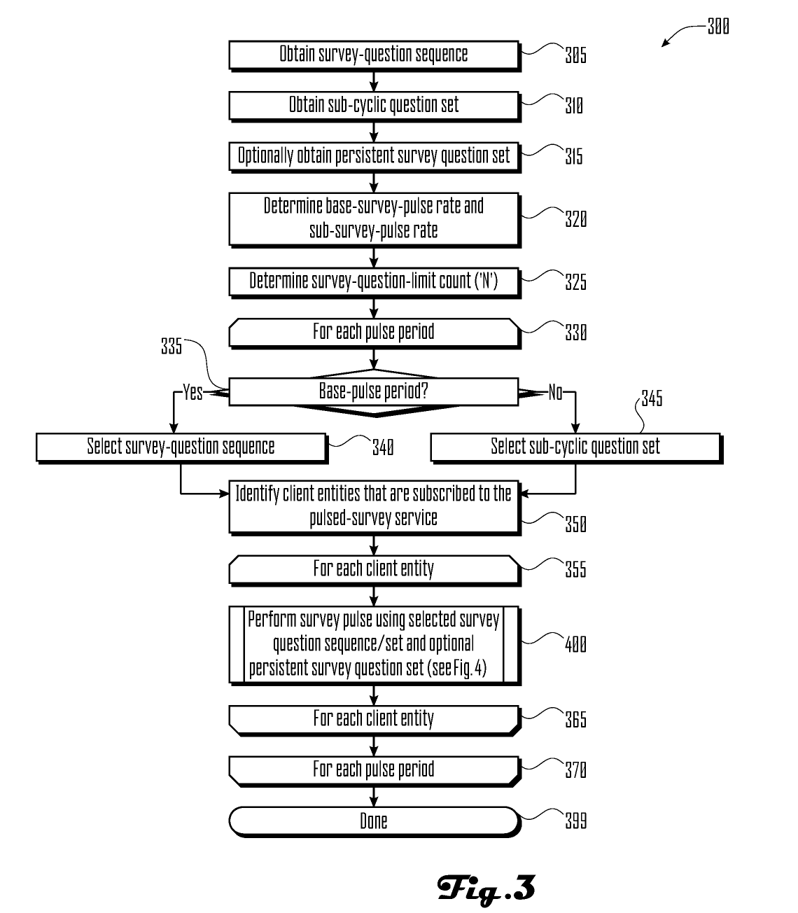

Memory 225 generally comprises a random access memory (“RAM”), a read only memory (“ROM”), and a permanent mass storage device, such as a disk drive. The memory 225 stores program code for a routine 300 for providing a pulsed-survey service (see FIG. 3, discussed below). In addition, the memory 225 also stores an operating system 235

These and other software components may be loaded into memory 225 of pulsed-survey server 200 using a drive mechanism (not shown) associated with a non-transient computer-readable medium 230, such as a floppy disc, tape, DVD/CD-ROM drive, memory card, or the like.

Memory 225 also includes survey database 240. In some embodiments, pulsed-survey server 200 may communicate with survey database 240 via network interface 210, a storage area network (“SAN”), a high-speed serial bus, and/or via the other suitable communication technology.

In some embodiments, survey database 240 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

FIG. 3 illustrates a routine 300 for providing a pulsed-survey service, such as may be performed by a pulsed-survey server 200 in accordance with one embodiment.

In block 305, routine 300 obtains a survey-question sequence comprising at least ten survey questions. Generally, survey questions within the survey-question sequence (like most survey questions) are not repeated or are repeated only infrequently and irregularly.

For example, in one embodiment, the survey-question sequence may include survey questions such as some or all of the following when employees are the intended survey recipients:

1. From a scale of 1-10, how happy are you at work?

2. Can you recite your organization's vision, mission, and cultural values?

3. What's one thing the company should continue doing to be more successful?

4. What's one thing the company should start doing to be more successful?

5. What's one thing the company should stop doing to be more successful?

6. From a scale of 1-10, how likely will you still be working here in one year?

7. From a scale of 1-10, how happy are you at work?

8. On a scale of 1-10, how valued do you feel at work?

9. On a scale of 1-10, how would you rate your company's future?

10. Who do you consider the company's most valuable player/contributor?

11. From a scale of 1-10, how happy are you at work?

12. What one thing would you implement to improve the company's culture?

Other examples of survey questions that may be included when surveying employees include survey questions such as some or all of the following.
What are three words you′d use to describe our culture?
What do you think is the company's biggest weakness?
Who do you consider the company's rookie of the year?
From a scale of 1-10, how likely will you be working here in three years?
What is the #1 issue you would change at the company?
What motivates you?
Do you feel that your manager has clearly defined your roles and responsibilities for the next quarter?
Aside from salary, what do you feel is the most valuable benefit of working at your company?
How knowledgeable are you about what others are working on who are outside of your department
From a scale of 1-10, how transparent do you feel management is?
If you had to describe your company as an animal, what animal would it be?
If you had to write your company's fortune for next year, what would you write for the fortune cookie?
Tell me one thing about the company that everyone knows/that everyone should know/that everyone but the CEO should know?
If you had to write your own fortune about your career here, what would you write/how long would you be here/why would you leave?
What is one thing that drives you crazy daily that you wish could be changed at this company?
How can management better improve communications?
From a scale of 1-10, how enthusiastically would you refer a friend to work here?□

Other embodiments may use more, fewer, and/or different survey questions that are oriented towards eliciting sentiments about a business entity from a certain type of recipient (e.g., employees, clients, and/or customers).

In block 310, routine 300 obtains a sub-cyclic question set comprising at least one sub-cyclic survey question. An at least one sub-cyclic survey question is one that (unlike most survey questions) is repeated every ‘M’ pulse periods (where ‘M’ is greater than one). Consequently, at least one sub-cyclic survey questions may be used to track long-term trends on a given question.

For example, in some embodiments, an at least one sub-cyclic survey question may be chosen to elicit responses that gauge respondents' overall happiness, engagement, and/or satisfaction with respect to a business entity. In one embodiment, a “happiness” survey question such as “From a scale of 1-10, how happy are you at work?” may be repeated on a four-week cycle, or “From a scale of 1-10, how happy are you with Company X?” may be repeated on a four-month cycle.

In block 315, routine 300 optionally obtains a persistent survey question set comprising at least one persistent survey question that is posed during every pulse period. Typically, a persistent survey question may provide the respondent with an opportunity to provide additional information related to a survey question, to provide free-form suggestions, to identify an employee of the business entity for recognition, or the like.

For example, in many cases, a non-persistent survey question may ask the respondent to rate something on a scale of 1-10, select from a bounded set of discrete options (e.g., select from statements A-D the statement that most closely matches your sentiment), answer yes or no, or otherwise provide a quantitative response. In some embodiments, an optional persistent survey question may also be posed, allowing the respondent to explain or comment on his or her quantitative answer in free-form text.

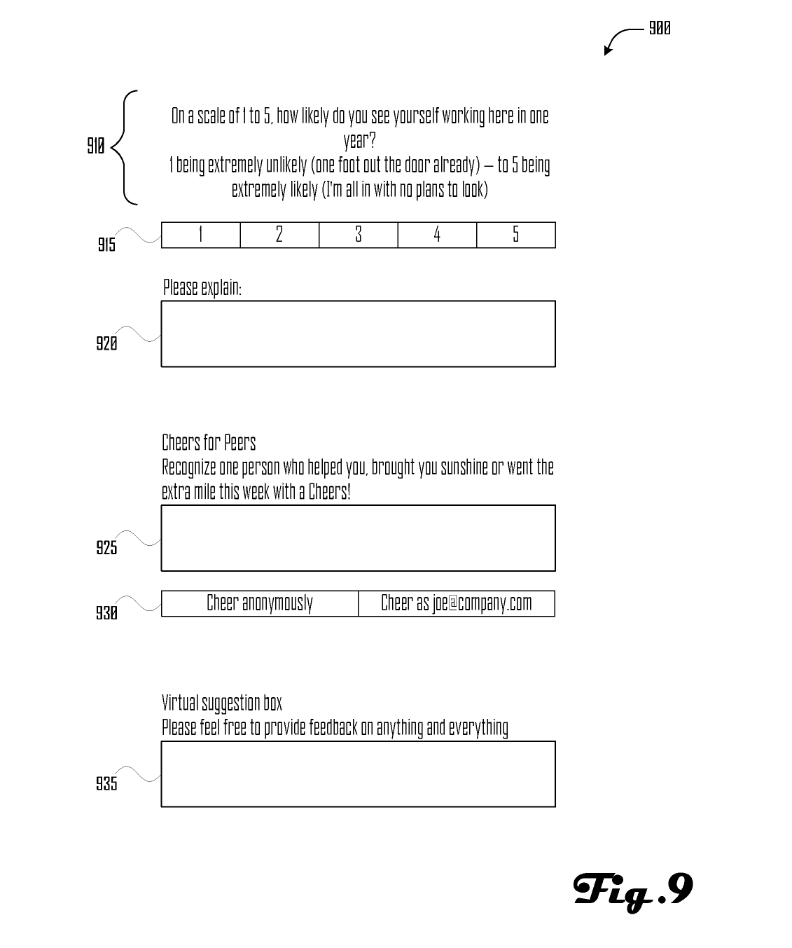

In some embodiments, in block 315, routine 300 may obtain a small number of survey questions that provide the respondent with an opportunity to provide certain information in all or most survey pulses. For example, in one embodiment, routine 300 may obtain a minimal set of optional survey questions including survey questions that allow the respondent to praise an employee of a business entity and/or to make suggestions or provide feedback on any topic. See, e.g., optional-recognition control 925 and suggestion control 935 of pulsed-survey interface 900 (see FIG. 9, discussed below).

In block 320, routine 300 determines a base-survey-pulse rate corresponding to a plurality of base pulse periods, the base-survey-pulse rate being no more frequent than one pulse period per day, and a sub-survey-pulse rate corresponding to a plurality of sub-pulse periods, the sub-survey-pulse rate being no more than half as frequent as the base-survey-pulse rate.

For example, in one embodiment, survey questions in the survey-question sequence may be pulsed at a base rate of once per week. In other embodiments, other base-survey-pulse rates may be employed. In many embodiments, base-survey-pulse rates should be high enough to encourage respondents to habitually provide responses, but low enough to not unduly interfere with respondent productivity.

In block 325, routine 300 determines a limit on the number of survey questions to pose during any pulse period. In one embodiment, survey pulses may each include only one survey question from the survey-question sequence (i.e., in such an embodiment, survey-question-limit count (‘N’) may be one). In other embodiments, survey pulses may include more than one survey question, although a survey pulse should not include more than ten percent of the survey questions in the survey-question sequence.

Beginning in opening loop block 330, routine 300 processes each pulse period in turn. In decision block 335, routine 300 determines whether the current pulse period is a base-pulse period (or a sub-survey-pulse rate). If so, then routine 300 proceeds to block 340. Otherwise (if the current pulse period is a sub-pulse period), then routine 300 proceeds to block 345.

For example, if the at least one sub-cyclic survey questions are repeated every fourth cycle, and it has been three cycles since the current pulse period was surveyed according to the at least one sub-cyclic survey questions, then in decision block 335, routine 300 may determine that the current pulse period is due to be surveyed according to the at least one sub-cyclic survey questions.

In block 340, routine 300 selects the survey-question sequence obtained in block 305 to be used when performing a survey pulse during the current pulse period. In block 345, routine 300 selects the sub-cyclic question set obtained in block 310 to be used when performing a survey pulse during the current pulse period.

In block 350, routine 300 identifies a multiplicity of client entities that are subscribed to the pulsed-survey service. Typically, a manager (or HR personnel) may indicate his or her desire to survey sentiments regarding the business entity from employees, clients, and/or customers by signing up for a service provided by pulsed-survey server 200. The manager typically also provides a list of email addresses or otherwise provides electronic contact information for a number of employees, clients, and/or customers who should be surveyed on a pulsed basis.

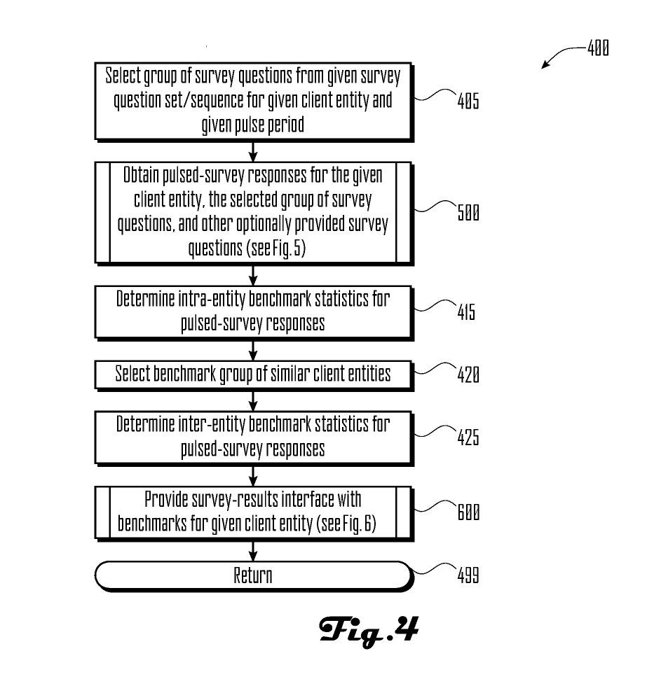

Beginning in opening loop block 355, routine 300 processes each client entity in turn. In subroutine block 400, routine 300 calls subroutine 400 (see FIG. 4, discussed below) to perform a survey pulse for the current client entity and the current pulse period using the survey question sequence selected in block 340 or the survey question or set selected in block 345.

In ending loop block 365, routine 300 iterates back to opening loop block 355 to process the next client entity, if any. In ending loop block 370, routine 300 iterates back to opening loop block 330 to process the next pulse period, if any. Routine 300 ends in ending block 399.

FIG. 4 illustrates a subroutine 400 for performing a survey pulse for a given client entity during a given pulse period from a given survey question set/sequence and an optional persistent survey question set, such as may be performed by a pulsed-survey server 200 in accordance with one embodiment.

In block 405, subroutine 400 selects a survey group including at least one survey question from the given survey question set/sequence, but including no more than ten percent of the survey questions of the given survey question set/sequence. In some embodiments, such as when given a survey-question sequence, selecting the survey group may include determining a position within the given survey question set/sequence for the given client entity, and selecting at least one survey question (but no more then ten percent) according to the determined position.

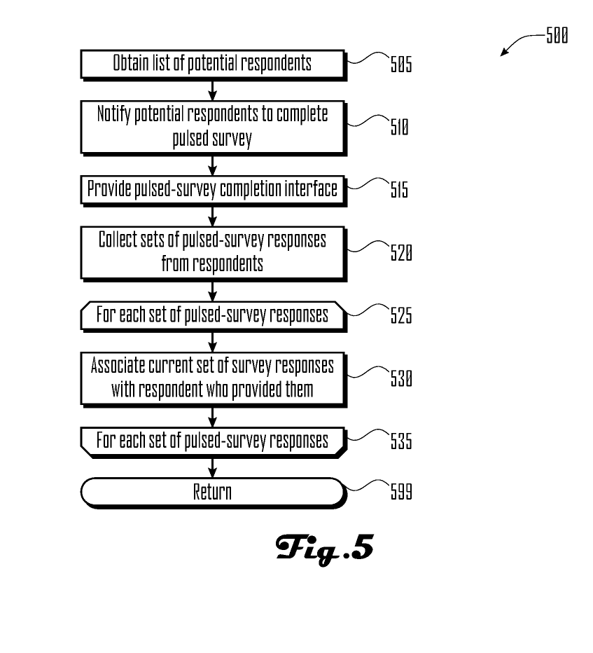

In subroutine block 500, subroutine 400 calls subroutine 500 (see FIG. 5, discussed below) to pose and obtain pulsed-survey responses for the given client entity for the selected group of survey questions and any optionally provided persistent survey questions.

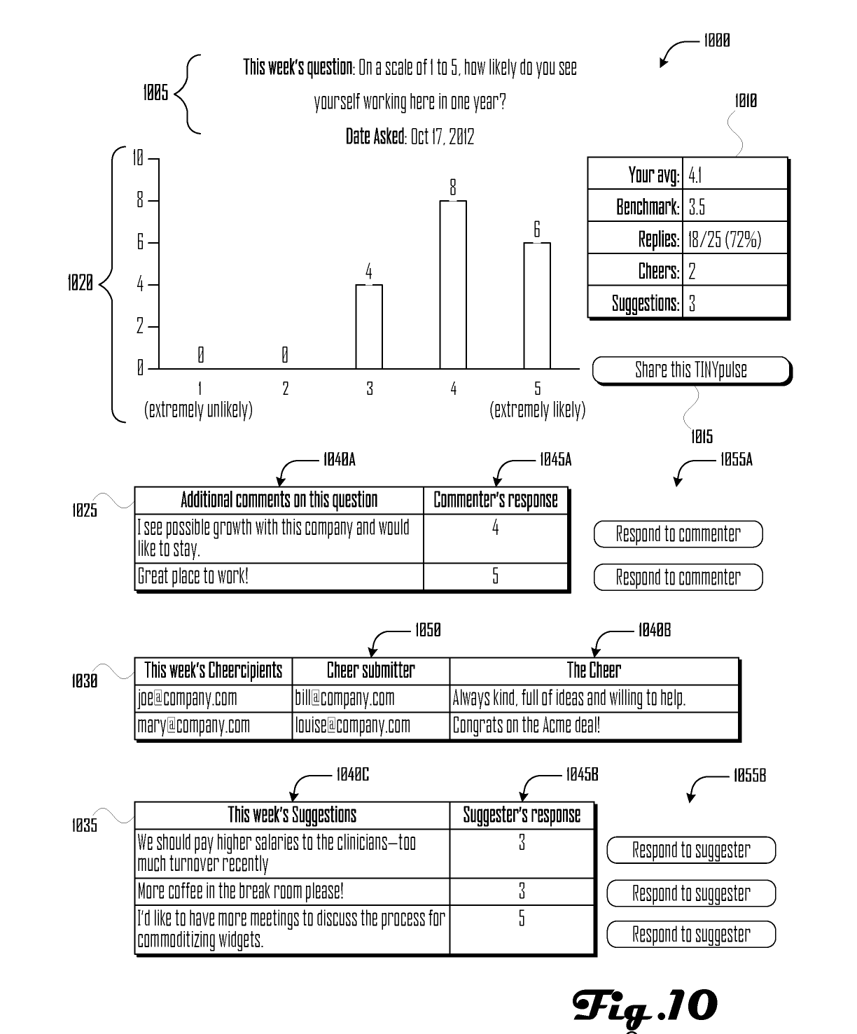

In block 415, subroutine 400 determines intra-entity benchmark statistics for the pulsed-survey responses obtained in subroutine block 500. See, e.g., survey-question statistical summary element 1010 (“Your avg”) of survey-responses dashboard interface 1000 (see FIG. 10, discussed below). For example, in one embodiment, subroutine 400 may determine and present an average quantitative response provided by respondents associated with the given client entity. In other embodiments, subroutine 400 may determine additional and/or different statistical measures, such as an arithmetic mean, a median, a mode, and/or other like statistical measures.

In block 420, subroutine 400 selects a “benchmark” group of business entities that share one or more similar traits with the given client entity. For example, in one embodiment, the “benchmark” group may include business entities that are of a similar size to the given client entity, that are located in a similar geographic region to the given client entity, that are in a similar business segment as the given client entity, and/or that are similar in some other respect. In other embodiments, a manager of the given client entity may provide a selection of some or all business entities to be included in the “benchmark” group.

In block 425, subroutine 400 determines inter-entity benchmark statistics for the pulsed-survey responses obtained in subroutine block 500. See, e.g., survey-question statistical summary element 1010 (“Benchmark”) of survey-responses dashboard interface 1000 (see FIG. 10, discussed below). For example, in one embodiment, subroutine 400 may determine and present an average quantitative response provided by respondents associated with the given client entity and among the “benchmark” group. In other embodiments, subroutine 400 may determine additional and/or different statistical measures, such as an arithmetic mean, a median, a mode, and/or other like statistical measures.

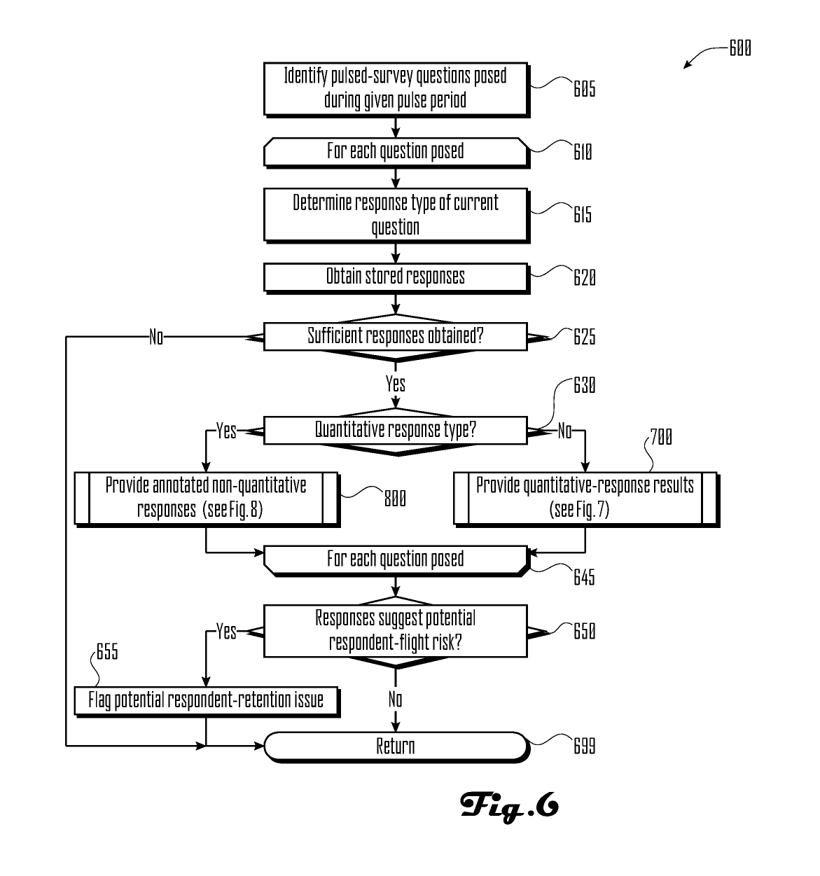

In subroutine block 600, subroutine 400 calls subroutine 600 (see FIG. 6, discussed below) to provide for presentation to the given client entity a survey-results interface including an intra-entity benchmark statistic, an inter-entity benchmark statistic, and a plurality of survey responses, said plurality of obtained survey responses being unattributable to a plurality of respondents. See, e.g., survey-responses dashboard interface 1000 (see FIG. 10, discussed below).

Subroutine 400 ends in ending block 499, returning to the caller.

FIG. 5 illustrates a subroutine 500 for obtaining pulsed-survey responses for a given survey question group for a given client entity during a given pulse period, such as may be performed by a pulsed-survey server 200 in accordance with one embodiment.

In block 505, subroutine 500 obtains a list identifying potential respondents associated with the business entity, which may in various embodiments be employees, clients, and/or customers. Typically such a list may have been provided by a manager of the business entity.

In block 510, subroutine 500 notifies the potential respondents that they are asked to complete a survey. For example, in one embodiment, subroutine 500 may send or cause to be sent emails, text messages, instant messages, direct messages, or other like electronic messages to the potential respondents. In some embodiments, the survey-availability notification may include (e.g., embedded in a link to a survey-completion interface) an identification code by which a given respondent's responses can be associated with that particular respondent. In some embodiments, a time-window for providing responses may close when the next pulse-period begins. In such embodiments, subroutine 500 may send periodic reminders to respondents who have not provided responses before a predetermined amount of time has passed (e.g., within five days from receiving the initial notification, when only two days remain until the time window closes, or the like).

In block 515, subroutine 500 provides an interface via which the potential respondents can submit responses to the given survey question set/sequence. See, e.g., pulsed-survey interface 900 (see FIG. 9, discussed below).

In block 520, subroutine 500 collects sets of pulsed-survey responses from some of all of the potential respondents (via the interface provided in block 515). Beginning in opening loop block 525, subroutine 500 processes each set of pulsed-survey responses in turn.

In block 530, subroutine 500 identifies which respondent provided the current set of pulsed-survey responses and associates the current set of pulsed-survey responses with the identified respondent (e.g., in survey database 240).

In ending loop block 535, subroutine 500 iterates back to opening loop block 525 to process the next set of pulsed-survey responses, if any.

Subroutine 500 ends in ending block 599, returning to the caller.

FIG. 6 illustrates a subroutine 600 for providing a survey-results interface for a given client entity and a given pulse period, such as may be performed by a pulsed-survey server 200 in accordance with one embodiment.

In block 605, subroutine 600 identifies one or more survey questions that were posed to employees, clients, and/or customers of the given client entity during the given pulse period. In various embodiments, the one or more survey questions may include one or more optional and/or persistent survey questions.

Beginning in opening loop block 610, subroutine 600 processes each survey question identified in block 605 in turn.

In block 615, subroutine 600 determines a response type associated with the current survey question. In some embodiments, “quantitative”-type survey questions may ask a respondent to, for example, rate something on a scale of 1-10, select from a bounded set of discrete options (e.g., select from statements A-D the statement that most closely matches your sentiment), answer yes or no, or otherwise provide a quantitative response. Contrastingly, non-quantitative-type questions may ask a respondent to, for example, provide free-form text or other non-quantitative input.

In block 620, subroutine 600 obtains stored responses (e.g. from survey database 240) that have been collected from one or more respondents to the current survey question.

In decision block 625, subroutine 600 determines whether a sufficient quantity of responses have been collected at the current point in time. In some embodiments, to preserve respondent anonymity (particularly if the respondents are employees of a smaller company), subroutine 600 may provide a survey-results “dashboard” only after a certain quantity of responses (e.g., five responses) have been collected. In other embodiments, subroutine 600 may determine whether to display results on a question-by-question basis, assessing each individual question's response count against a predetermined threshold. If such a response-quantity threshold has not been met, then subroutine 600 may proceed to ending block 699, possibly providing a notification that an insufficient quantity of responses have been obtained. Otherwise, if a sufficient quantity of responses has been obtained, subroutine 600 proceeds to decision block 630.

In decision block 630, subroutine 600 determines whether the response-type of the current survey question (as determined in block 615) is quantitative or non-quantitative. If the current survey question is quantitative, then subroutine 600 proceeds to call subroutine 800. Otherwise, subroutine 600 proceeds to call subroutine 700.

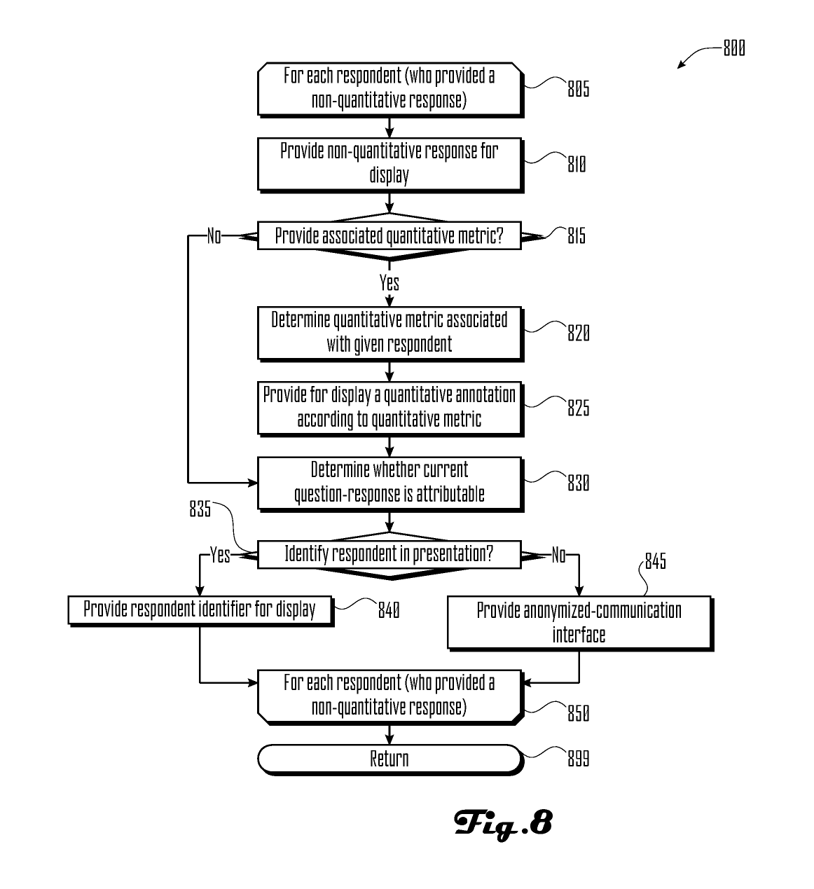

In subroutine block 800, subroutine 600 calls subroutine 800 (see FIG. 8, discussed below) to provide a results display for the current non-quantitative survey question.

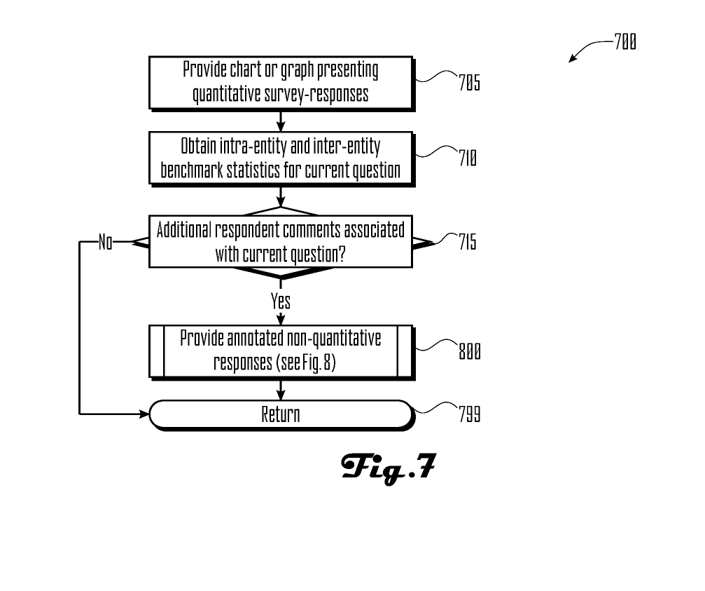

In subroutine block 700, subroutine 600 calls subroutine 700 (see FIG. 7, discussed below) to provide a results display for the current quantitative survey question.

In ending loop block 645, subroutine 600 iterates back to opening loop block 610 to process the next survey question identified in block 605, if any.

In decision block 650, subroutine 600 determines whether the responses obtained in block 620 suggest that one or more respondents are a potential risk to sever their relationships with the business entity in the foreseeable future, such as by resigning (in the case of employee-respondents) or finding another vendor to provide goods and/or services provided by the business entity (in the case of client- or customer-respondents).

For example, in some embodiments managers of business entities may from time to time identify certain respondents who had previously been sent one or more surveys, but who have since have severed their relationships with the business entities. Once a statistically significant quantity of severed-relationship respondents have been identified (across one or more business entities), the survey-responses provided by the severed-relationship respondents may be analyzed to identify patterns that may be predictive of respondents who are likely to sever their relationships with business entity. For example, in some cases, survey responses that indicate low satisfaction and/or engagement may be predictive. In other cases, a decrease in the quantity and/or kind of survey-responses provided may also be predictive.

If in decision block 650, subroutine 600 determines that one or more respondents are a potential risk to sever their relationships with business entity in the foreseeable future, then subroutine 600 proceeds to block 655.

In block 655, subroutine 600 modifies the dashboard presentation to indicate to the viewing manager that one or more respondents have provided survey responses indicating that they may sever their relationship with the business entity in the foreseeable future. In some embodiments, such as when the respondents are employees at risk of quitting, the respondents are not identified to the manager by name or otherwise.

Subroutine 600 ends in ending block 699.

FIG. 7 illustrates a subroutine 700 for providing a results display for a given quantitative survey question and a given client entity, such as may be performed by a pulsed-survey server 200 in accordance with one embodiment.

In block 705, subroutine 700 provides to a remote manager a chart or graph presenting quantitative responses to quantitative survey questions, the responses having been provided by respondents corresponding to the given client entity. See, e.g., quantitative-responses chart 1020 of survey-responses dashboard interface 1000 (see FIG. 10, discussed below).

In block 710, subroutine 700 obtains intra-entity and inter-entity benchmark statistics for current question. See, e.g., block 415 and block 425 (see FIG. 4, discussed above).

In decision block 715, subroutine 700 determines whether the respondents who provided quantitative responses to quantitative survey questions also provided comments or other non-quantitative responses associated with their quantitative responses.

In subroutine block 800, subroutine 700 calls subroutine 800 (see FIG. 8, discussed below) to provide annotated non-quantitative responses associated with the quantitative responses to the quantitative survey question. See, e.g., anonymized-communication element 1130 of survey-responses dashboard interface 1000 (see FIG. 10, discussed below).

Subroutine 700 ends in ending block 799, returning to the caller.

FIG. 8 illustrates a subroutine 800 for providing a results display for a non-quantitative survey question, such as may be performed by a pulsed-survey server 200 in accordance with one embodiment.

Beginning in opening loop block 805, subroutine 800 processes each respondent who provided a non-quantitative response in turn.

In block 810, subroutine 800 provides to a remote manager the non-quantitative response provided by the current respondent. See, e.g., non-quantitative response column 1140A-C of survey-responses dashboard interface 1000 (see FIG. 10, discussed below).

In decision block 815, subroutine 800 determines whether a quantitative metric is associated with the non-quantitative survey question, and if so, whether to provide the quantitative metric to the remote manager. For example, in one embodiment, a certain type of non-quantitative survey question (e.g., a survey question asking the respondent to comment on a quantitative survey question) may correspond to a quantitative survey question, and such a non-quantitative survey question may customarily be presented along with an annotation indicating the respondent's answer to the corresponding quantitative survey question.

If in decision block 815, subroutine 800 determines that a quantitative metric is associated with the non-quantitative survey question, then subroutine 800 proceeds to block 820.

In block 820, subroutine 800 determines a quantitative metric associated with the non-quantitative survey question and the current respondent. For example, in one embodiment, the determined quantitative metric may be the value provided by the respondent in response to the non-quantitative survey question.

In block 825, subroutine 800 provides for display to the remote manager a quantitative annotation corresponding to the quantitative metric determined in block 820. See, e.g., quantitative annotation columns 1145A-B of survey-responses dashboard interface 1000 (see FIG. 10, discussed below).

In block 830, subroutine 800 determines whether the response provided by the current respondent is attributable, such that the current respondent may be identified to the remote manager. For example, in most cases, survey question responses (quantitative or otherwise) are kept confidential (i.e., not-attributable), such that the identity of the respondent is never revealed to a remote manager. However, some survey questions may be optionally or selectably non-anonymous or attributable. See, e.g., optional-recognition control 925 of pulsed-survey interface 900 (see FIG. 9, discussed below).

In decision block 835, subroutine 800 determines, based on the attribution determination made in block 830, whether to present to the remote manager identifying information associated with the respondent. If subroutine 800 determines to present identifying information, then subroutine 800 proceeds to block 840. Otherwise, subroutine 800 proceeds to block 845.

In block 840, subroutine 800 provides for display to the remote manager identifying information (e.g., a name, an email address, or other respondent identifier) associated with the current respondent. See, e.g., respondent-identifier column 1050 of survey-responses dashboard interface 1000 (see FIG. 10, discussed below).

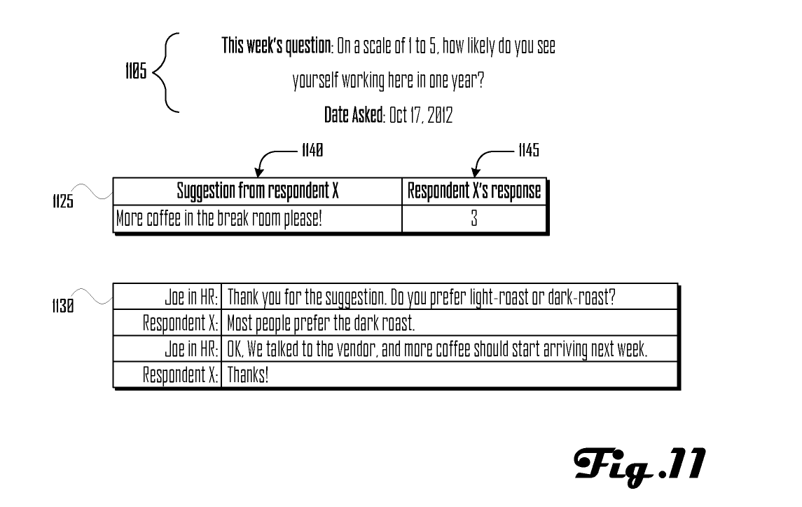

In block 845, subroutine 800 provides an anonymized-communication interface enabling anonymized communication with some or all of a plurality of respondents who provided a plurality of comments. See, e.g., anonymized-communication interface 1100 (see FIG. 11, discussed below).

In ending loop block 850, subroutine 800 iterates back to opening loop block 805 to process the next respondent who provided a non-quantitative response, if any.

Subroutine 800 ends in ending block 899, returning to the caller.

FIG. 9 illustrates an exemplary pulsed-survey interface 900 posing survey questions to a respondent, in accordance with one embodiment.

Survey-question display 910 poses a survey question to a respondent.

Quantitative-response controls 915 enable the respondent to respond to provide a quantitative response to the survey question posed by survey-question display 910.

Optional-explanation control 920 enables the respondent to provide free-form text to explain and/or comment on his or her answer to the survey question posed by survey-question display 910.

Optional-recognition control 925 enables the respondent to provide free-form text to praise or otherwise recognize a co-worker or other individual. In other embodiments, optional-recognition control 925 may be further associated with a control (not shown) enabling the respondent to select among a list of potentially recognizable individuals.

Attribution control 930 enables the respondent to indicate whether any praise provided via optional-recognition control 925 should be attributed to the respondent (here, “joe@company.com”) or whether any such praise should remain anonymous.

Suggestion control 935 enables the respondent to make suggestions or provide feedback on any topic.

FIG. 10 illustrates an exemplary survey-responses dashboard interface 1000, in accordance with one embodiment. In the illustrated example, the respondents are employees of the business entity. In other embodiments, the respondents may be employees, clients, and/or customers associated with the business entity.

Survey-question element 1005 presents a survey question that was posed to respondents associated with a business entity on an indicated date.

Survey-question statistical summary element 1010 presents a plurality of statistical measures associated with the survey questions posed on the indicated date. In the illustrated example, survey-question statistical summary element 1010 presents an average of quantitative results provided by respondents associated with a given business entity, as well as a “benchmark” average of quantitative results provided to the same survey question by respondents associated with a set of similar business entities. Survey-question statistical summary element 1010 also includes a response-rate percentage and counts indicating how many respondents provided responses to two optional survey questions.

Results-sharing control 1015 enables the manager who is viewing the survey-responses dashboard interface 1000 to create a “sharing interface” (not shown) including some or all of the information presented in survey-responses dashboard interface 1000 for exposure to respondents, the public, and/or others.

Quantitative-responses chart 1020 presents a graphical summary of quantitative responses provided by respondents of the given business entity to the survey question indicated by survey-question element 1105. In the illustrated example, quantitative-responses chart 1020 indicates that zero respondents provided quantitative responses of ‘1’ and ‘2’, four respondents provided a quantitative response of ‘3’, eight respondents provided a quantitative response of ‘4’, and six respondents provided a quantitative response of ‘5’.

Annotated non-quantitative responses elements 1025A-C present comments or other non-quantitative responses that were provided by some or all of the respondents (i.e., respondents who provided the quantitative responses presented in quantitative-responses chart 1020). In some embodiments, the comments are annotated with the quantitative response values provided by the commenter. For example, as illustrated, annotated non-quantitative responses elements 1025 indicates that the commenter who provided the comment, “Great place to work!”, also provided a quantitative response of ‘5’ to the quantitative survey question.

In non-quantitative response columns 1040A-C, individual non-quantitative responses provided by respondents are displayed. In quantitative annotation columns 1045A-B, individual quantitative annotations corresponding to non-quantitative responses are displayed. In respondent-identifier column 1050, respondent-identifying information is displayed.

Anonymous-communication control 1055A-B enables the manager who is viewing the survey-responses dashboard interface 1000 to create an anonymous-communication interface enabling anonymized communication with a respondent. See, e.g., anonymized-communication interface 1100 (see FIG. 11, discussed below).

FIG. 11 illustrates an exemplary anonymized-communication interface 1100 enabling anonymized communication with a given respondent who provided a non-attributed, non-quantitative response to a given survey question, in accordance with one embodiment.

Survey-question element 1105 presents a survey question that was posed to the given respondent associated with a business entity on an indicated date.

Annotated non-quantitative response element 1125 presents comments or other non-quantitative responses that were provided by the given respondent. In some embodiments, the comments are annotated with the quantitative response values provided by the commenter.

Anonymized-communication element 1130 enables communication between a manager and an anonymous respondent. In non-quantitative response column 1140, an individual non-quantitative response provided by the given respondent is displayed. In quantitative annotation columns 1145, an individual quantitative annotation corresponding to non-quantitative response is displayed.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

Additional details, embodiments, and alternatives are described below.

In an additional/alternative commercial embodiment to the embodiment(s) described above, an individual actor may register an organization as client entity of a goal tracking and alignment provider and have some or all of the organization's employees invited to participate. Although embodiments of the present systems and methods are generally described herein as applied to an organization as a whole, they may similarly be applied at a group or team level within a larger organization.

Individual actors may provide the goal tracking and alignment provider with one or more organizational-level goals on behalf of an organization client entity. Generally, an organizational-level goal may be a statement describing something the organization wishes to accomplish.

In certain embodiments, the goal tracking and alignment provider may limit the number of organization-level goals a particular organization can have open (i.e. be considered active by the system) during any one goal assessment interval. For example, the number of open organizational-level goals may be capped at three. The organization may also identify to the goal tracking and alignment provider one or more stakeholders associated with supporting a particular organizational-level goal (also referred to as a “goal-supporter”).

In certain embodiments, the goal tracking and alignment provider may also allow goal progress milestones to be defined for an organizational-level goal. For example, if an online retail company may have an organizational-level goal of increasing sales by 10% over the previous year, there may be monthly goal progress milestones associated with the organizational-level goal that require a 10% sales increase over the same month from the previous year in order to be fulfilled.

Individual actors within the organization, e.g. employees, tasked with various roles may then be invited to define one or more individual-level goals aimed at furthering one or more of the organization's organization-level goals (such individual-level goals may be intended to directly further an organizational level goal or may be intended to indirectly further an organizational level goal by directly furthering another individual-level goal). For example, a software company's organizational-level goal may be to commercially release a new version of a software product before the end of the current fiscal year and an individual programmer within the software company, and/or the individual programmer's manager, may set an individual-level goal for the individual programmer of completing revisions to a particular component of the software product during the current quarter.

In accordance with various embodiments of the present methods and systems, an actor, such as the individual programmer in the above example, and/or the actor's supervisor may submit an individual-level goal definition to the goal tracking and alignment system. The individual-level goal definition may:
include a goal statement (e.g. a human-readable articulation of the goal itself);
include a target date for completing the goal;
include a progress and alignment assessment frequency;
identify an actor as being responsible for completing the goal (generally referred to hereafter as the “goal-owner”),
identify another actor, such as the goal-owner's supervisor, as being in a managing role with respect to the individual-level goal (generally referred to hereafter as the “goal-supervisor”); and/or
identify a related-goal, such as an organizational-level goal or an intermediate-level goal, described below, the individual-level goal is intended to further.

In certain embodiments, the goal tracking and alignment provider may also allow goal progress milestones to be defined for an organizational-level goal.

The present goal tracking and alignment system may responsively provide both the goal-owner and the goal-supervisor with communications, prompts, reminders, notifications, and/or the like (referred to hereafter as “assessment notifications”) at various intervals, for example defined by the provided alignment assessment frequency or a default alignment frequency, intended to encourage both the goal-owner and the goal-supervisor to provide a brief update/assessment of the goal-owner's progress towards completing the individual-level goal.

In response to an assessment notification, the goal-owner and goal-supervisor may each provide the present goal tracking and alignment system with a subjective rating of the goal-owner's progress towards completing the individual goal since the previous progress assessment. Providing the rating may, for example, involve selecting one of three possible ratings for the current assessment interval: exceeded expectations, met expectations, failed to meet expectations. In various embodiments, both the goal-owner and goal-supervisor may be encouraged to provide an explanatory statement in conjunction with the provided rating.

Upon receiving a rating from both the goal-owner and the goal-supervisor, the present goal tracking and alignment system may compare the ratings and determine whether the goal-owner's subjective assessment of the goal-owner's progress towards the goal and the goal-supervisor's subjective assessment of the goal-owner's progress towards the goal are: aligned (i.e. match), misaligned (e.g. the goal-owner's rating is failed to meet expectations and the goal-supervisor's rating is met expectations), or severely misaligned (e.g. the goal-supervisor's rating failed to meet expectations and the goal-owner's rating is exceeded expectations). The goal-tracking and alignment system may then provide both the goal-owner and the goal-supervisor with a goal assessment update indicating the alignment (or lack thereof) between the goal-owner and the goal-supervisor's subjective assessments of the goal-owner's progress. The goal tracking and alignment system may also provide historical data, if available, showing a trend of assessment alignment (or lack thereof) over time with respect to the individual-level goal as well as progress towards goal and/or milestone completion.

In instances where misalignment between the goal-owner's rating and the goal-supervisor's rating exceeds a predefined threshold the goal tracking and alignment system exceeds a predetermined misalignment threshold, the goal tracking and alignment system may provide the goal-owner and/or the goal-supervisor with access to resources designed to improve the alignment and/or schedule a goal counseling session between the goal-owner, the goal-supervisor, and/or a additional actors, such as a peer adviser, a human resources representative, or the like.

In accordance with various embodiments, the goal tracking and alignment system may permit an actor, such as a goal-supervisor of one or more individual-level goals, to be a goal-owner of related-goal, wherein the actor's completion of the related-goal is at least partially dependent on the completion of one or more of the individual-level goals the actor is supervising. Completion of a related-goal may or may not also involve direct action by the goal-owner. For example, a team manager who supervises a team of subordinate employees may be designated as goal-supervisor with respect to one or more individual-level goals “owned” by the subordinate employees and may be a goal-owner of a related-goal. Completion of the related-goal may be dependent on the completion of a defined number of the individual-level goals “supervised” by the manager.

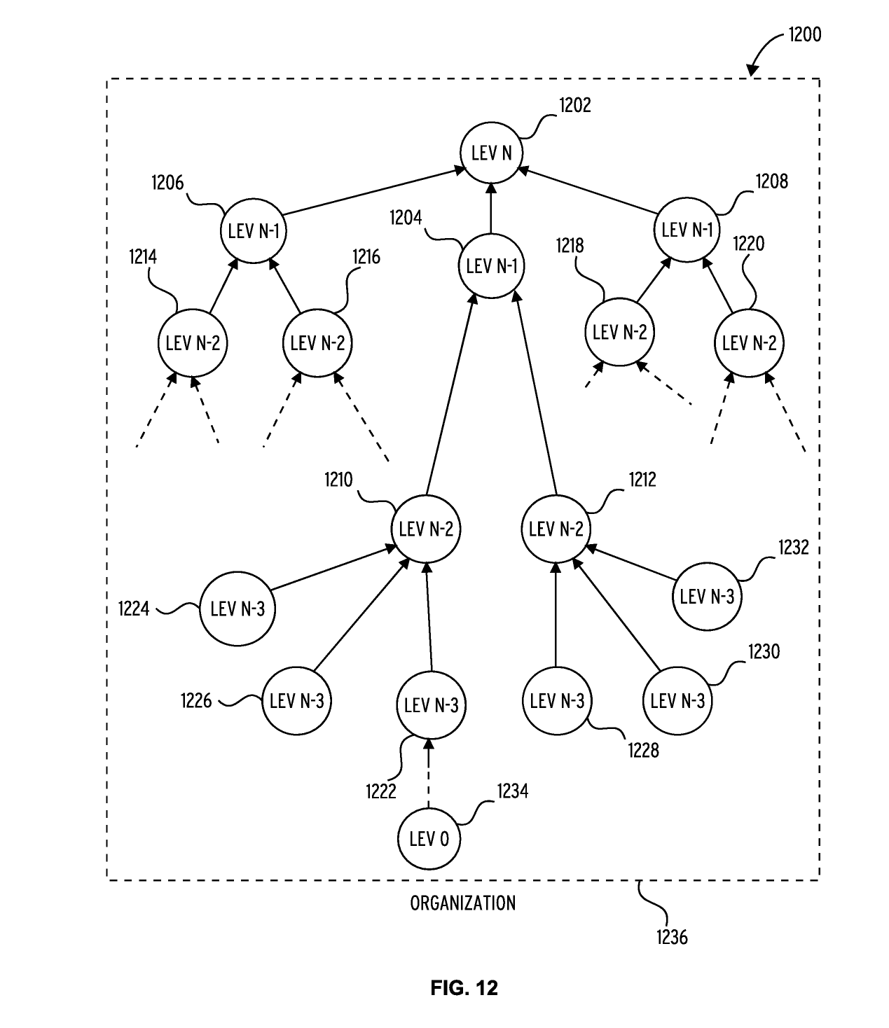

By way of example, FIG. 12 illustrates a generic and simplified organizational chart 1200 for an organization (not shown). An organizational chart such as exemplary organizational chart 1200 typically illustrates the structure of an organization and the relationships and relative ranks of the organization's various parts and positions/jobs. Such relationships might include those between managers and subordinate employees, department heads and managers, vice presidents and department heads, a chief executive officer and vice presidents, etc.

Each node 1202-1234 in organizational chart 1200 represents an individual actor (or group of actors) such as an employee, executive, manager, independent contractor, member, volunteer, or the like in an organization. Each actor has a level of seniority, from zero, for the least senior employees, to N, for the most senior, such as a CEO. Each arrow indicates a direction of responsibility and/or reporting for a given actor. For example, actor 1224, actor 1226 and actor 1222 may represent relatively low-level employees who report to a relatively more senior actor 1210, e.g. a group leader. In turn, actor 1210 reports to actor 1204, who in turn reports to the highest-level actor of organizational chart 1200, represented by actor 1202.

Senior actor 1202 may provide the goal tracking and alignment provider with one or more organizational-level goal definitions, as described above. In various embodiments, goal tracking and alignment provider may also be provided with identifying information for other actors within organization 1236 and/or organizational structure data for organization 1236, similar to the structure data provided in organizational chart 1200.

The goal tracking and alignment provider may then provide actor 1204, actor 1206, and actor 1208 with opportunities to define individual-level goals intended to further one or more of the organization-level goals. Actor 1204, actor 1206, and actor 1208 may then request goal tracking and alignment provider to provide their subordinate employees, if any, with a similar opportunity to define individual-level goals intended to further one or more of the organizational-level goals (such individual-level goals may be intended to directly further an organizational level goal or may be intended to indirectly further an organizational level goal by directly furthering another individual-level goal).

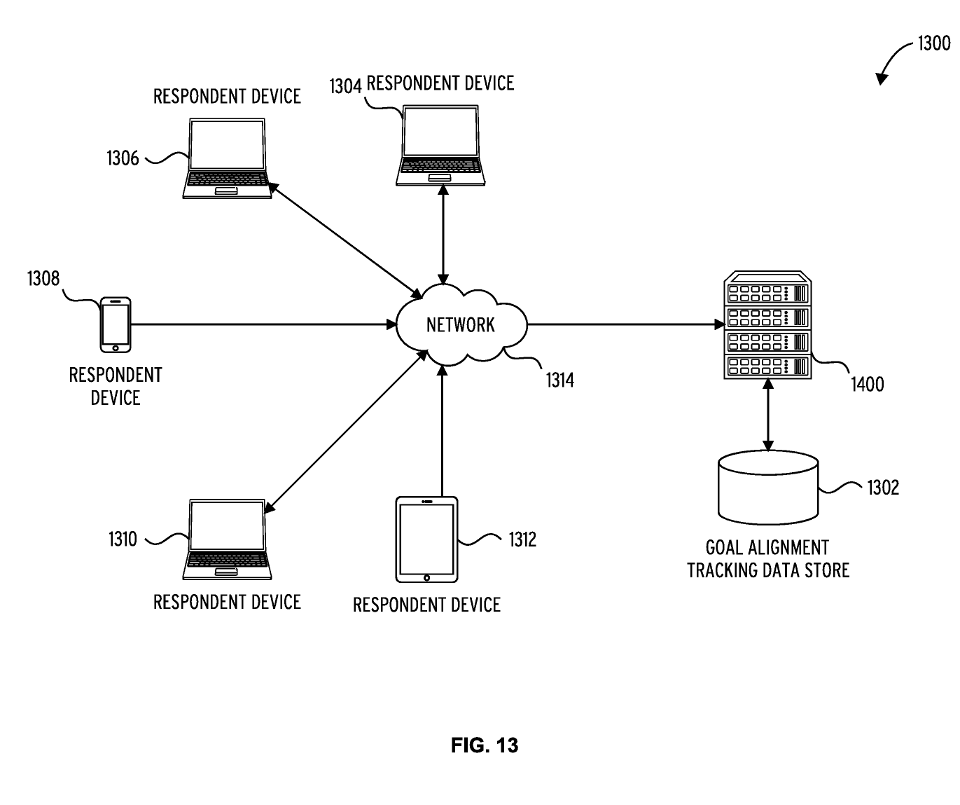

FIG. 13 illustrates an exemplary network topology of a goal alignment tracking system 1300 in accordance with various embodiments. Respondent device 1304, respondent device 1306, respondent device 1308, respondent device 1310, respondent device 1312, and remote goal alignment tracking server 1400 are in data communication with a network 1314. In various embodiments, network 1314 may include the Internet, one or more local area networks (“LANs”), one or more wide area networks (“WANs”), cellular data networks, and/or other data networks. Network 1314 may, at various points, be a wired and/or wireless network. Remote goal alignment tracking server 1400 may be in data communication with a goal alignment tracking data store 1302.

In various embodiments, any of client devices 1304-1312 may be networked computing devices having form factors including general purpose computers (including “desktop,” “laptop,” “notebook” “tablet” computers, or the like); mobile phones; watches, glasses, or other wearable computing devices. In the example shown in FIG. 13, five respondent devices are shown, respondent device 1304, respondent device 1306, and respondent device 1310 are depicted as laptop/notebook computers, respondent device 1308 is depicted as a mobile-phone, and respondent device 1312 is depicted as a tablet computer. In various embodiments there may be fewer or many more respondent devices than are shown in FIG. 13.

In many embodiments, additional business entities may be represented within the system, and each business entity may include more employee, respondent, and/or manager devices than are displayed in FIG. 13.

In some embodiments, goal alignment tracking data store may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

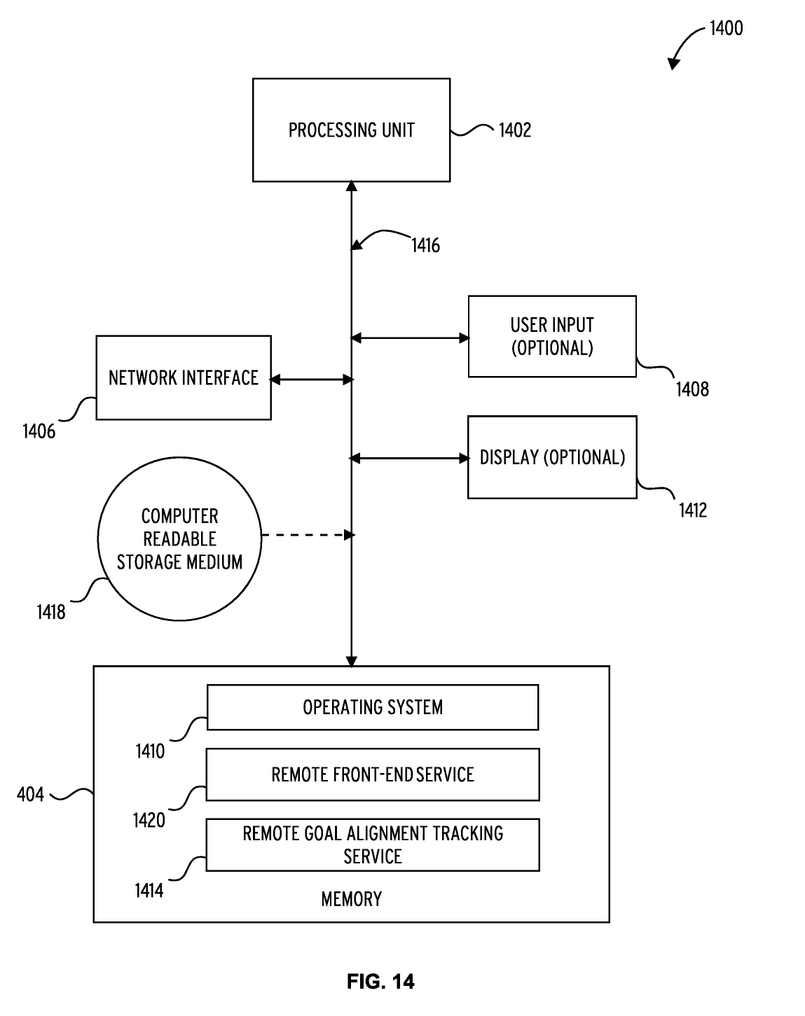

As is described in more detail below, in various embodiments, remote goal alignment tracking server 1400 may be a networked computing device generally capable of accepting requests over network 1314 e.g. from any one of respondent devices 1304-1312 and/or other networked computing devices (not shown), and providing responses accordingly. The functional components of an exemplary remote goal alignment tracking server 1400 are described below in reference to FIG. 14.

Referring to FIG. 14, several components of an exemplary remote goal alignment tracking server 1400 are illustrated. In some embodiments, a remote goal alignment tracking server 1400 may include many more components than those shown in FIG. 14. However, it is not necessary that all of these generally conventional components be shown in order to disclose an illustrative embodiment. As shown in FIG. 14, exemplary remote goal alignment tracking server 1400 includes a processing unit 1402 in data communication with memory 1404 via a bus 1416. Memory 1404 generally comprises some or all of random access memory (RAM), read-only memory (ROM), and/or a permanent mass storage device, such as a disk drive, flash memory, or the like. Remote goal alignment tracking server 1400 may also include a network interface 1406 for communicating with other computing devices via a network, a user input (optional) 1408, a display (optional) 1412.

Memory 1404 of exemplary remote goal alignment tracking server 1400 may store an operating system 1410, as well as program code for a number of software applications, such as a remote goal alignment tracking service 1414 and a remote front-end service 1420. As is described in more detail below, remote goal alignment tracking service 1414 is a software program for enabling users to record goals and assess their and/or others' progress towards meeting those goals. In various embodiments, remote goal alignment tracking service 1414 may also determine whether two or more stakeholders are aligned in their subjective view of one of the stakeholders progress towards meeting a goal. In various embodiments, remote goal alignment tracking service 1414 may identify severe misalignment between stakeholders and encourage additional analysis and/or investigation. Remote front-end service 1420 may enable communication between remote goal alignment tracking service 1414 and users operating web browser applications and/or dedicated client applications operating on respondent devices 1304-12.

These and other software components, as well as various data files (not shown) may be loaded into memory 1404 via network interface 1406 (or via a selectively removable computer readable storage medium 1418, such as a memory card or the like).

In operation, operating system 1410 manages the hardware and software resources of the remote goal alignment tracking server 1400 and provides common services for various software applications, such as remote goal alignment tracking service 1414. For hardware functions such as network communications via network interface 1406, obtaining data via user input (optional) 1408, rendering data via display (optional) 1412, allocation of memory 1404 to various resources, and the like operating system 1410 may act as an intermediary between software executing on remote goal alignment tracking server 1400 and the client device's hardware.

Although an exemplary remote goal alignment tracking server 1400 has been described, a remote goal alignment tracking server 1400 may be any of a great number of computing devices capable executing program code, such as the program code corresponding to operating system 1410 and remote goal alignment tracking service 1414 and communicating with other computing devices via a network. Remote goal alignment tracking server 1400 may also communicate via bus 1416 and/or network interface 1406 with one or more data stores (not shown). In some cases, a remote goal alignment tracking server 1400 may comprise one or more replicated and/or distributed physical or logical devices. In cases, one or more instantiations of a remote goal alignment tracking server 1400 may be embodied by the same physical device.

In some embodiments, remote goal alignment tracking server 1400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

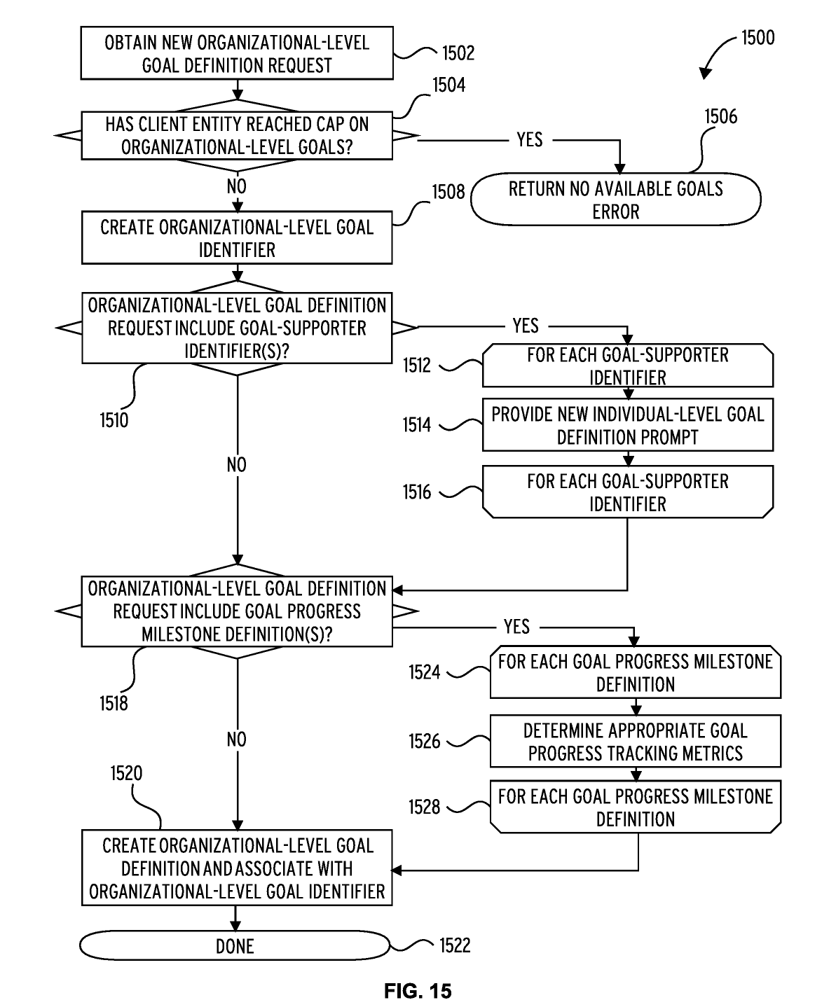

FIG. 15 illustrates an organizational-level goal definition routine 1500, which may be performed by remote goal alignment tracking service 1414 operating on remote goal alignment tracking server 1400 in furtherance of a goal alignment tracking provider.

In block 1502, organizational-level goal definition routine 1500 may obtain an organizational-level goal definition request from a client entity, such as a company or other organization via remote front-end service 1420. Typically, an organization's key stakeholder(s), such as a President, CEO, or other high-level executive may have responsibility for defining the organization's organization-level goals. The organizational-level goal definition request may include:
a client entity identifier;
a goal statement, e.g. a human-readable statement describing an aspect of what the organization is striving to accomplish (e.g. achieve profitability, grow by X %, increase community awareness, etc.);
a goal completion target date; and
one or more goal-owner identifiers, e.g. actors within the organization who are responsible for driving the organization to meet the particular organizational-level goal.

In various embodiments an organizational-level goal definition request may optionally include:
one or more goal progress milestone definitions; and/or
one ore more goal-supporter identifiers.

The number of organizational-level goals permitted by organizational-level goal definition routine 1500 may be capped, for example at three. At decision block 1504, if the number of existing organizational-level goals associated with the client entity identifier equals the predefined cap on organizational-level goals, organizational-level goal definition routine 1500 may proceed to return block 1506 and return a no available goals error message in response to the new organizational-level goal definition request. Otherwise, organizational-level goal definition routine 1500 may proceed to block 1508.

In block 1508, organizational-level goal definition routine 1500 creates an organizational-level goal identifier to associate with the new organizational-level goal definition request.

At decision block 1510, if the organizational-level goal definition request includes one or more goal-supporter identifiers, organizational-level goal definition routine 1500 may proceed to opening loop block 1512; otherwise organizational-level goal definition routine 1500 may proceed to decision block 1518.

Beginning at opening loop block 1512, organizational-level goal definition routine 1500 process each goal-supporter identifier in turn.

In block 1514, organizational-level goal definition routine 1500 may provide a new individual-level goal definition prompt to an electronic contact associated with the current goal-supporter identifier. For example, organizational-level goal definition routine 1500 may send a message to an electronic mail address associated with the current goal-supporter identifier including a link to a URI for creating a new individual-level goal.

At closing loop block 1516, organizational-level goal definition routine 1500 iterates back to opening loop block 1512 and processes the next goal-supporter identifier included in the organizational-level goal definition request, if any. After each goal-supporter identifier has been processed, organizational-level goal definition routine 1500 may proceed to decision block 1518.

At decision block 1518, if the organizational-level goal definition request includes one or more goal progress milestone definitions, organizational-level goal definition routine 1500 may proceed to opening loop block 1524; otherwise organizational-level goal definition routine 1500 may proceed to block 1520.

Beginning at opening loop block 1524, organizational-level goal definition routine 1500 process each goal progress milestone definition in turn.

In block 1526, organizational-level goal definition routine 1500 may determine one or more appropriate goal progress tracking metrics for the current goal progress definition.

At closing loop block 1528, organizational-level goal definition routine 1500 iterates back to opening loop block 1524 and processes the next goal progress milestone definition included in the organizational-level goal definition request, if any. After each goal progress milestone has been processed, organizational-level goal definition routine 1500 may proceed to block 1520.

In block 1520, organizational-level goal definition routine 1500 may create an organizational-level goal definition record corresponding to data obtained in the organizational-level goal definition request and associate the organizational-level goal definition record with the organizational-level goal identifier, for example in goal alignment tracking data store 1302.

Organizational-level goal definition routine 1500 ends at ending block 1522.

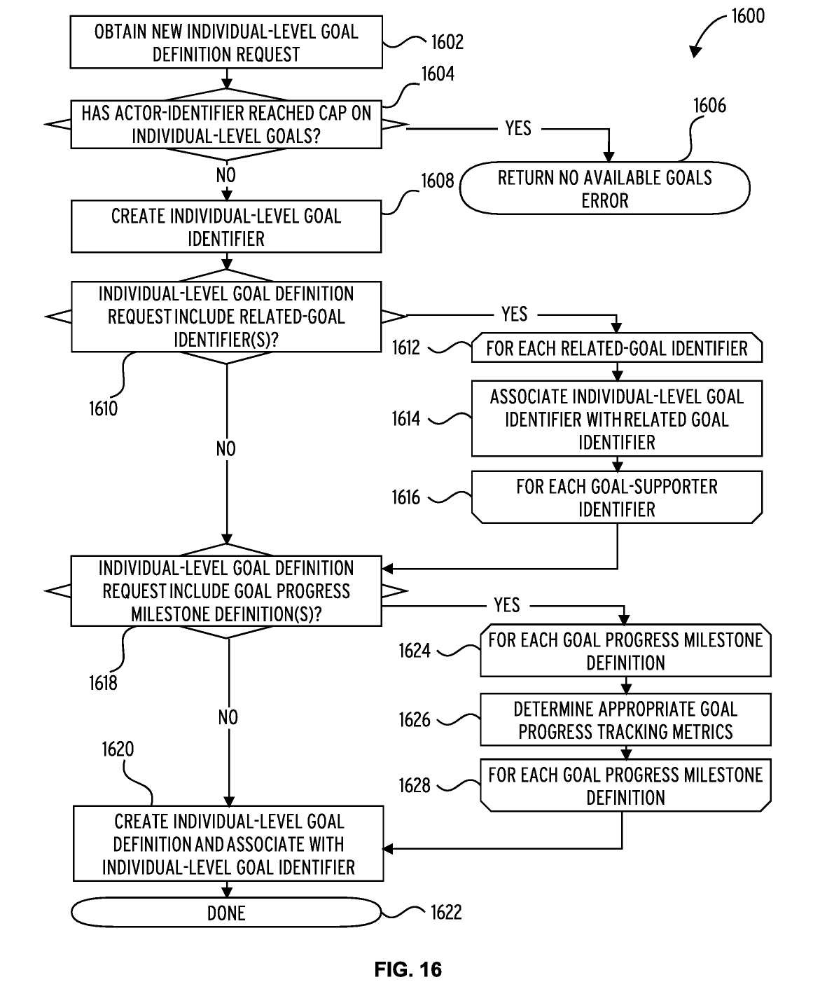

FIG. 16 illustrates an individual-level goal definition routine 1600 for defining an individual-level goal, which may be performed by remote goal alignment tracking service 1414 operating on remote goal alignment tracking server 1400 in furtherance of a goal alignment tracking provider.

In block 1602, individual-level goal definition routine 1600 may obtain an individual-level goal definition request via remote front-end service 1420, e.g. from an actor affiliated with a client-entity operating one of respondent devices 1304-1308. The individual-level goal definition request may include:
a goal-owner identifier, corresponding to the individual actor responsible for completing the individual goal;
a goal-supervisor identifier, corresponding to the individual actor responsible for supervising/managing the goal-owner's progress towards completing the individual goal;
a client entity identifier;
a goal statement, e.g. a human-readable statement describing an aspect of what the goal-owner is striving to accomplish (e.g. complete Y project, open Z new accounts, etc.);
an assessment interval; and
a goal completion target date.

In various embodiments an organizational-level goal definition request may optionally include:
one or more goal progress milestone definitions; and/or
one ore more related-goal identifiers.

The number of individual-level goals “owned” per actor may be capped by individual-level goal definition routine 1600, for example at three. At decision block 1604, if the number of existing individual-level goals associated with the goal-owner identifier equals the predefined cap on individual-level goals, individual-level goal definition routine 1600 may proceed to return block 1606 and return a no available goals error message in response to the new individual-level goal definition request. Otherwise, individual-level goal definition routine 1600 may proceed to block 1608.

In block 1608, individual-level goal definition routine 1600 creates an individual-level goal identifier to associate with the new individual-level goal definition request.

At decision block 1610, if the individual-level goal definition request includes one or more related-goal identifiers, individual-level goal definition routine 1600 may proceed to opening loop block 1612; otherwise individual-level goal definition routine 1600 may proceed to decision block 1618.

Beginning at opening loop block 1612, individual-level goal definition routine 1600 process each related-goal identifier in turn.

In block 1614, individual-level goal definition routine 1600 may associate the newly created individual-level goal identifier with records associated with the current related-goal identifier, for example in goal alignment tracking data store 1302.

At closing loop block 1616, individual-level goal definition routine 1600 iterates back to opening loop block 1612 and processes the next related-goal identifier included in the individual-level goal definition request, if any. After each related-goal identifier has been processed, individual-level goal definition routine 1600 may proceed to decision block 1618.

At decision block 1618, if the individual-level goal definition request includes one or more goal progress milestone definitions, individual-level goal definition routine 1600 may proceed to opening loop block 1624; otherwise individual-level goal definition routine 1600 may proceed to block 1620.

Beginning at opening loop block 1624, individual-level goal definition routine 1600 process each goal progress milestone definition in turn.

In block 1626, individual-level goal definition routine 1600 may determine one or more appropriate goal progress tracking metrics for the current goal progress definition.

At closing loop block 1628, individual-level goal definition routine 1600 iterates back to opening loop block 1624 and processes the next goal progress milestone definition included in the organizational-level goal definition request, if any. After each goal progress milestone has been processed, individual-level goal definition routine 1600 may proceed to block 1620.

In block 1620, individual-level goal definition routine 1600 may create an individual-level goal definition record corresponding to data obtained in the individual-level goal definition request and associate the individual-level goal definition record with the individual-level goal identifier, for example in goal alignment tracking data store 1302.

Individual-level goal definition routine 1600 ends at return block 1622.

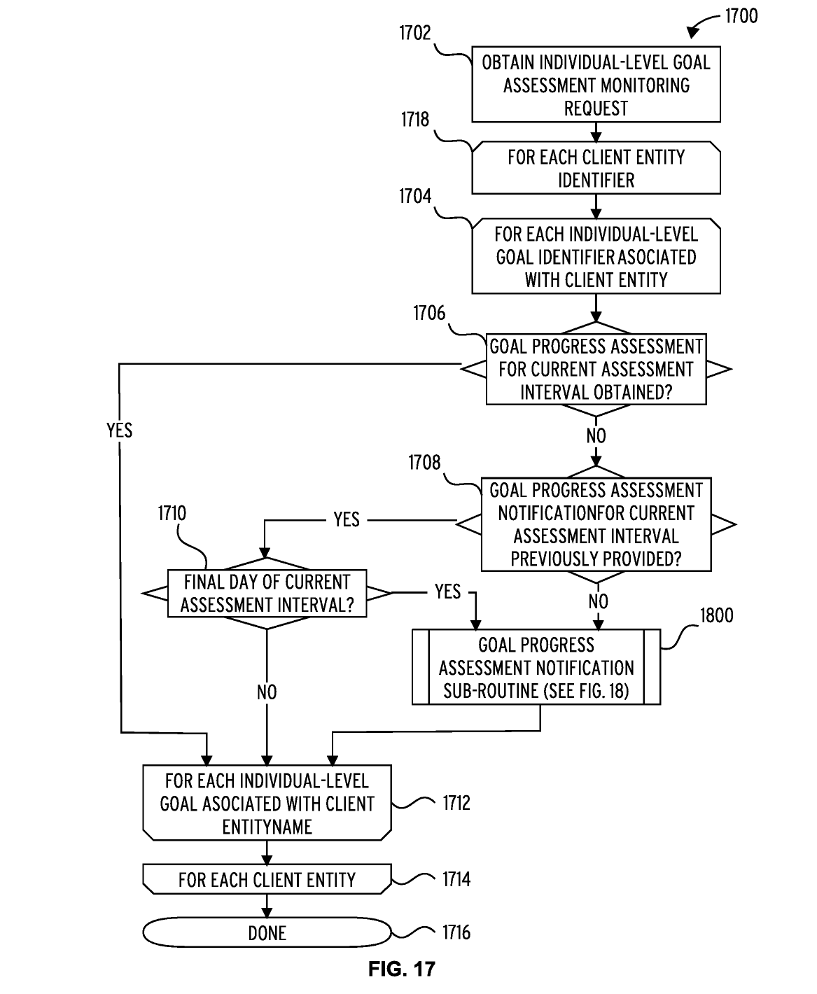

FIG. 17 illustrates an individual-level goal monitoring routine 1700, such as may be performed by remote goal alignment tracking service 1414 operating on remote goal alignment tracking server 1400 in furtherance of a goal alignment tracking provider. Individual-level goal monitoring routine 1700 may be automatically performed at regular intervals by remote goal alignment tracking service 1414, e.g. once a day, in order to encourage various actors associated with client entities of the goal alignment tracking provider to provide regular assessments of their progress towards completing various goals.

In block 1702, individual-level goal monitoring routine 1700 is initiated by obtaining an individual-level goal assessment monitoring request.

At opening loop block 1718, individual-level goal monitoring routine 1700 may process each client entity identifier of the goal alignment tracking provider in turn.

At opening loop block 1704, individual-level goal monitoring routine 1700 may process each individual-level goal identifier associated with the current client entity in turn.

At decision block 1706, if a goal progress assessment for the current assessment interval associated with the individual-level goal identifier has previously been obtained, individual-level goal monitoring routine 1700 may proceed to ending loop block 1712; otherwise individual-level goal monitoring routine 1700 may proceed to decision block 1708.

At decision block 1708, if a goal progress assessment notification for the current assessment interval associated with the individual-level goal identifier has previously been provided, individual-level goal monitoring routine 1700 may proceed to 1710; otherwise individual-level goal monitoring routine 1700 may proceed to goal progress assessment notification sub-routine 1800.

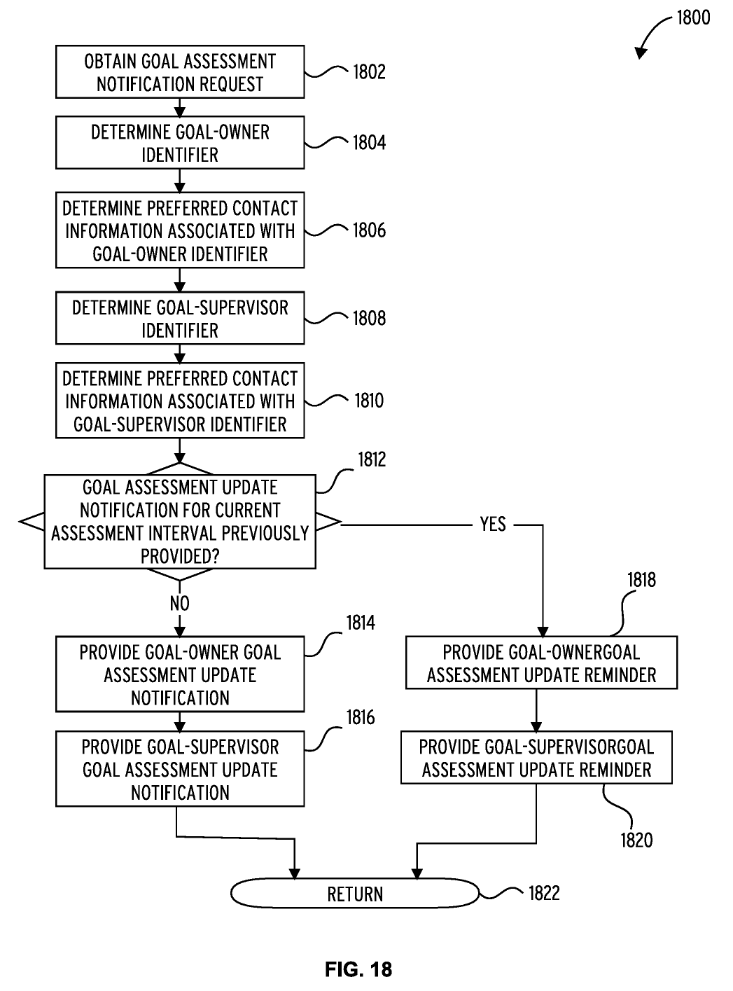

In goal progress assessment notification sub-routine 1800, individual-level goal monitoring routine 1700 calls goal progress assessment notification sub-routine 1800 (see FIG. 18, discussed below).

In ending loop block 1712, individual-level goal monitoring routine 1700 iterates back to opening loop block 1704 to process the next individual-level goal identifier, if any.

In ending loop block 1714, individual-level goal monitoring routine 1700 iterates back to opening loop block 1718 to process the next client entity identifier, if any.

Individual-level goal monitoring routine 1700 ends at termination block 1716.

FIG. 18 illustrates a goal progress assessment notification sub-routine 1800, such as may be performed by remote goal alignment tracking service 1414 operating on remote goal alignment tracking server 1400 in furtherance of a goal alignment tracking provider. Goal progress assessment notification sub-routine 1800 may be performed in response to a goal assessment notification request, for example obtained from individual-level goal monitoring routine 1700.

In block 1802, goal progress assessment notification sub-routine 1800 obtains a goal assessment notification request. The goal assessment notification request may include an individual-level goal identifier.

In block 1804, goal progress assessment notification sub-routine 1800 may determine a goal-owner identifier associated with the individual-level goal definition. In block 1806, goal progress assessment notification sub-routine 1800 may determine preferred contact information, such as an electronic mail address or the like, associated with the goal-owner identifier.

In block 1808, goal progress assessment notification sub-routine 1800 may determine a goal-supervisor identifier associated with the individual-level goal identifier. In block 1810, goal progress assessment notification sub-routine 1800 may determine preferred contact information, such as electronic mail address or the like, associated with the goal-supervisor identifier.

At decision block 1812, if a goal assessment update notification for the current assessment interval has not previously been provided, goal progress assessment notification sub-routine 1800 may proceed to block 1814; otherwise goal progress assessment notification sub-routine 1800 may proceed to block 1818.

In block 1814, goal progress assessment notification sub-routine 1800 may provide a goal-owner assessment update notification via the preferred contact information for the goal-owner identifier. In block 1816, goal progress assessment notification sub-routine 1800 may provide a goal-supervisor assessment update notification via the preferred contact information for the goal-supervisor identifier. For example, goal progress assessment notification sub-routine 1800 may generate electronic mail messages notifying the goal-owner and goal-supervisor a new assessment interval has begun and encouraging the goal owner and goal-supervisor to provide a subjective goal progress assessment update with respect to goal associated with the individual-level goal identifier to remote goal alignment tracking service 1414 for the new assessment interval.

In block 1818, goal progress assessment notification sub-routine 1800 may provide a goal-owner assessment update reminder via the preferred contact information for the goal-owner identifier. In block 1820, goal progress assessment notification sub-routine 1800 may provide a goal-supervisor assessment update reminder via the preferred contact information for the goal-supervisor identifier. For example, goal progress assessment notification sub-routine 1800 may generate electronic mail messages notifying the goal-owner and goal-supervisor the current assessment interval is almost over and encouraging the goal owner and goal-supervisor to provide a subjective goal progress assessment update with respect to goal associated with the individual-level goal identifier to remote goal alignment tracking service 1414 for the current assessment interval.

Goal progress assessment notification sub-routine 1800 terminates at return block 1822.

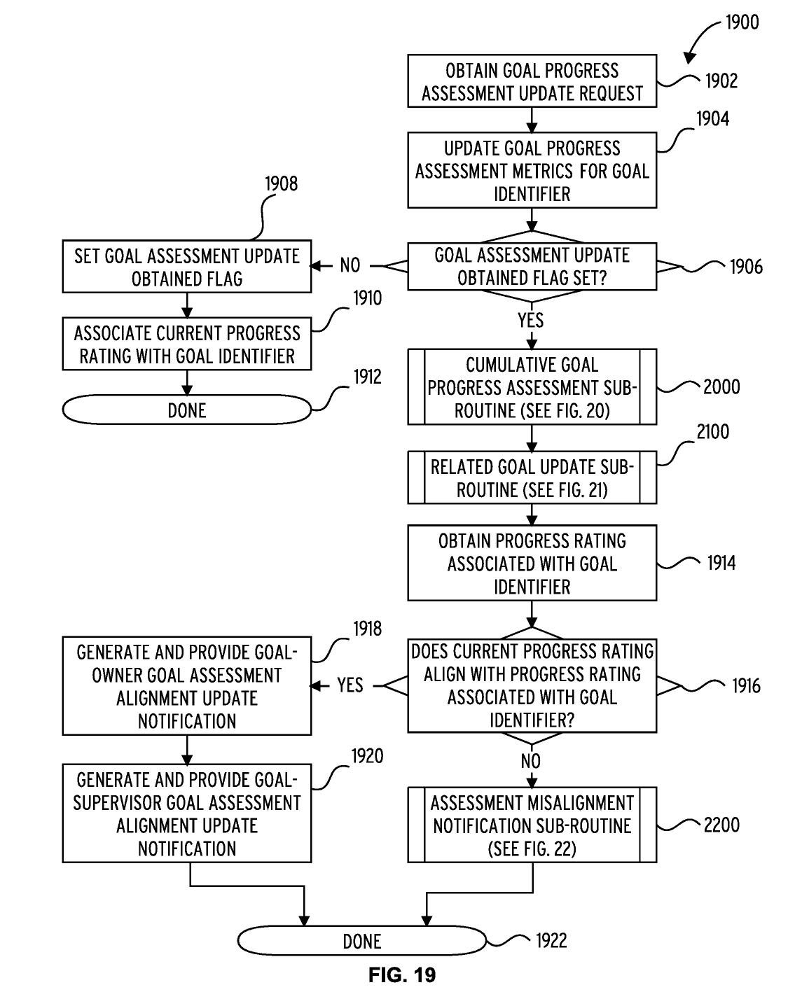

FIG. 19 illustrates a goal progress assessment update routine 1900 such as may be performed by remote goal alignment tracking service 1414 operating on remote goal alignment tracking server 1400 in furtherance of a goal alignment tracking provider. Goal progress assessment update routine 1900 may be performed in response to a goal progress assessment update request, for example obtained via remote front-end service 1420.

In block 1902, goal progress assessment update routine 1900 obtains a goal assessment update request. The goal assessment update request may include:
an individual-level goal identifier;
an actor identifier, which may correspond to either the goal-owner identifier or the goal-supervisor associated with the individual-level goal identifier; and
a subjective progress rating.

In accordance with various embodiments, the goal assessment update request may also include:
a progress assessment statement; and/or
one or more goal progress assessment metrics.

In various embodiments, the subjective progress rating may have one of three values: met expectations, exceeded expectations, or did not meet expectations.

In block 1904, goal progress assessment update routine 1900 updates any goal progress assessment metrics associated with the individual-level goal identifier with data obtained in the goal progress assessment update request.

At decision block 1906, if a goal assessment update obtained flag associated with the individual-level goal identifier is not set, indicating the current goal progress assessment update is the first update received for the current assessment interval, goal progress assessment update routine 1900 may proceed to block 1908; otherwise, i.e. if the current goal progress assessment update is the second update received for the current assessment interval, goal progress assessment update routine 1900 may proceed to sub-routine block 2000.

In block 1908, goal progress assessment update routine 1900 sets the individual-level goal identifier's goal assessment update obtained flag for the current assessment interval. In 1910, goal progress assessment update routine 1900 associates the subjective progress rating obtained via the goal progress assessment update request with the individual-level goal identifier, e.g. in goal alignment tracking data store 1302. Goal progress assessment update routine 1900 may then terminate at ending block 1912.

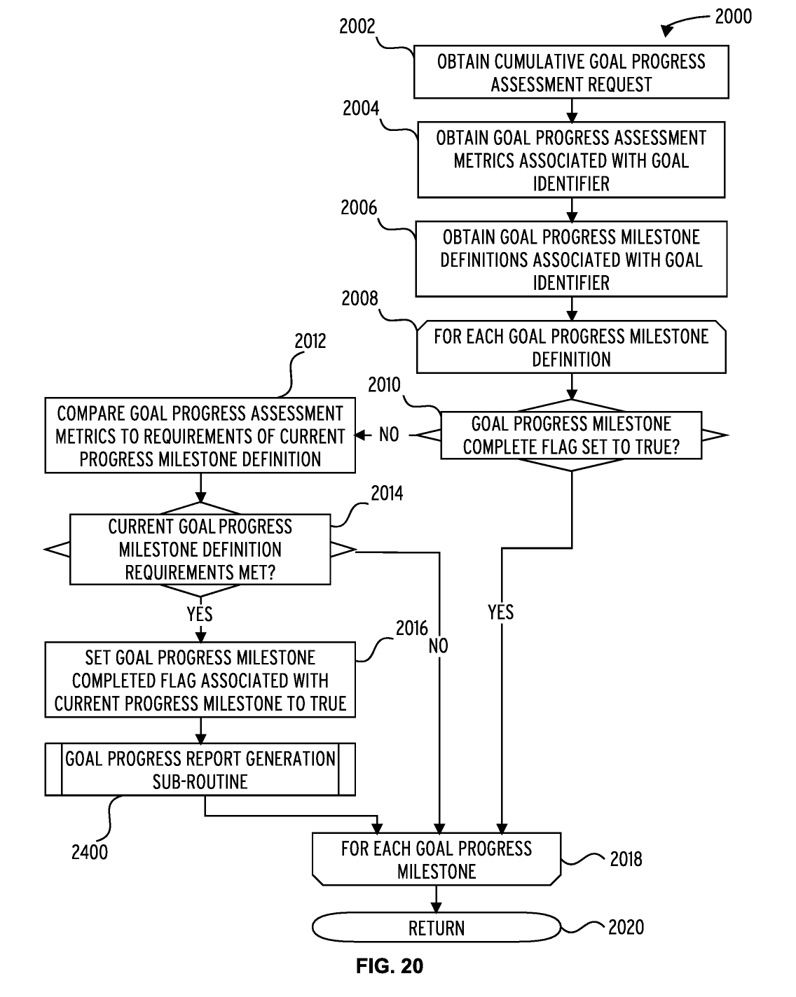

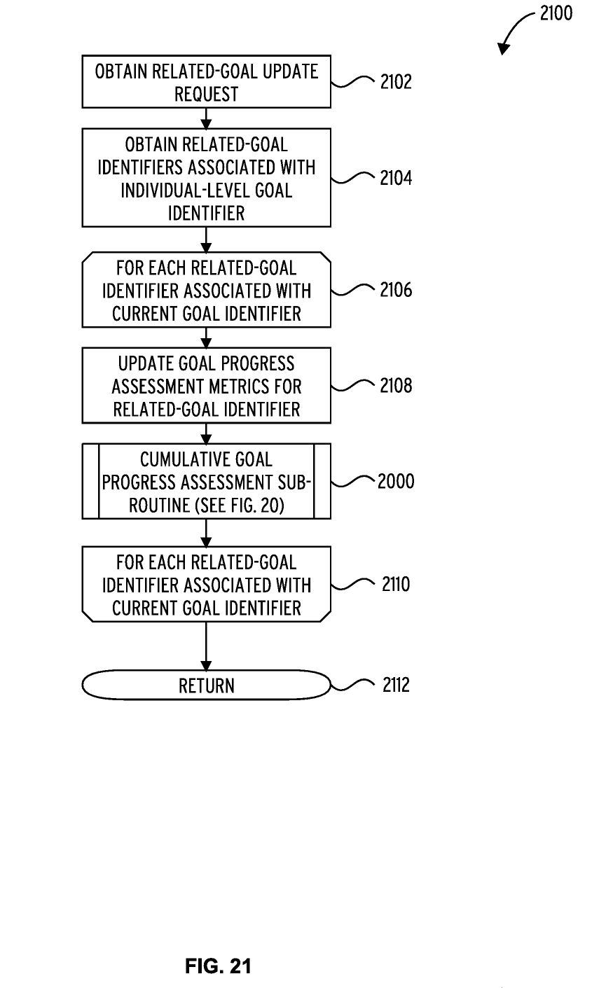

In sub-routine block 2000, goal progress assessment update routine 1900 calls cumulative goal progress assessment sub-routine 2000 described below in reference to FIG. 20. Goal progress assessment update routine 1900 may then proceed to sub-routine block 2100. In sub-routine block 2100, goal progress assessment update routine 1900 calls related-goal update sub-routine 2100, described below in reference to FIG. 21. Goal progress assessment update routine 1900 may then proceed to block 1914.

In block 1914, goal progress assessment update routine 1900 may obtain a subjective progress rating for the current assessment interval previously associated with the individual-level goal identifier (i.e. at block 1910 during a previous execution of goal progress assessment update routine 1900).

At decision block 1916, if the subjective progress rating obtained with the current goal progress assessment update request in block 1902 matches the subjective progress rating obtained in block 1914, goal progress assessment update routine 1900 may proceed to block 1918. Otherwise, goal progress assessment update routine 1900 may proceed to sub-routine block 2200, wherein goal progress assessment update routine 1900 calls assessment misalignment notification sub-routine 2200 and then terminates at ending block 1922.

In block 1918, goal progress assessment update routine 1900 generates a goal-owner assessment alignment update notification and provides the goal-owner assessment alignment update notification to the goal-owner. In block 1920, goal progress assessment update routine 1900 generates a goal-supervisor assessment alignment update notification and provides the goal-supervisor assessment alignment update notification to the goal-supervisor. For example, goal progress assessment update routine 1900 may generate electronic mail messages notifying the goal-owner and goal-supervisor their respective assessments of the goal-owners progress on the corresponding goal for the current assessment interval are in alignment. The notifications may also include any progress assessment statements and/or goal progress assessment metrics that may have been provided with one or both goal progress assessment update requests. The notifications may also include data provided by cumulative goal progress assessment sub-routine 2000.

Goal progress assessment update routine 1900 terminates at 1922.

FIG. 20 illustrates a cumulative goal progress assessment sub-routine 2000, such as may be performed by remote goal alignment tracking service 1414 operating on remote goal alignment tracking server 1400 in furtherance of a goal alignment tracking provider. Cumulative goal progress assessment sub-routine 2000 may be performed in response to a cumulative goal progress assessment request, for example obtained from goal progress assessment update routine 1900.

In block 2002, cumulative goal progress assessment sub-routine 2000 obtains a cumulative goal progress assessment request. The cumulative goal progress assessment request may include an individual-level goal identifier.

In block 2004, cumulative goal progress assessment sub-routine 2000 may obtain one or more goal progress assessment metrics associated with the individual-level goal identifier, for example from goal alignment tracking data store 1302.

In block 2006, cumulative goal progress assessment sub-routine 2000 may obtain one or more goal progress milestones associated with the individual-level goal identifier, for example from goal alignment tracking data store 1302.

At opening loop block 2008, cumulative goal progress assessment sub-routine 2000 may process each goal progress milestone associated with the individual-level goal identifier in turn.

At decision block 2010, if a goal progress milestone complete flag associated with the current goal progress milestone is set to true, indicating the current goal progress milestone has already been competed, then cumulative goal progress assessment sub-routine 2000 may proceed to closing loop block 2018; otherwise, cumulative goal progress assessment sub-routine 2000 my proceed to block 2012.

In block 2012, cumulative goal progress assessment sub-routine 2000 compares the goal progress assessment metrics associated with the current individual-level goal identifier to the requirements of the current goal progress milestone definition.

At decision block 2014, if the requirements of the current goal progress milestone definition are met, 2000 may proceed to block 2016; otherwise, routine 2000 may proceed to closing loop block 2018.

In block 2016, cumulative goal progress assessment sub-routine 2000 sets the goal progress milestone complete flag associated with the current individual-level goal identifier to true.

At sub-routine block 2400, cumulative goal progress assessment sub-routine 2000 calls goal progress review sub-routine 2300. Cumulative goal progress assessment sub-routine 2000 may then proceed to closing loop block 2018.

At 2018, cumulative goal progress assessment sub-routine 2000 iterates back to the next goal progress milestone definition associated with the individual-level goal progress identifier, if any.

Cumulative goal progress assessment sub-routine 2000 terminates at return block 2020.

FIG. 21 illustrates a related-goal update sub-routine 2100 such as may be performed by remote goal alignment tracking service 1414 operating on remote goal alignment tracking server 1400 in furtherance of a goal alignment tracking provider. Related-goal update sub-routine 2100 may be performed in response to a related-goal update request, for example obtained from goal progress assessment update routine 1900.

In block 2102, related-goal update sub-routine 2100 obtains a related-goal update request. The related-goal update request may include an individual-level goal identifier.

At block 2104, related-goal update sub-routine 2100 obtains related-goal identifiers associated with the individual-level goal identifier, if any.

At opening loop block 2106, related-goal update sub-routine 2100 processes each related-goal identifier in turn.

In block 2108, related-goal update sub-routine 2100 may update any goal progress assessment metrics associated with the current related-goal identifier, e.g. with data obtained in the goal progress assessment update request at block 1902, above.

In sub-routine block 2000, related-goal update sub-routine 2100 calls cumulative goal progress assessment sub-routine 2000, described above in reference to FIG. 20, for the current related-goal identifier.

At closing loop block 2110, related-goal update sub-routine 2100 may iterate to the next related-goal identifier associated with the individual-level goal identifier, if any.

Related-goal update sub-routine 2100 terminates at return block 2112.

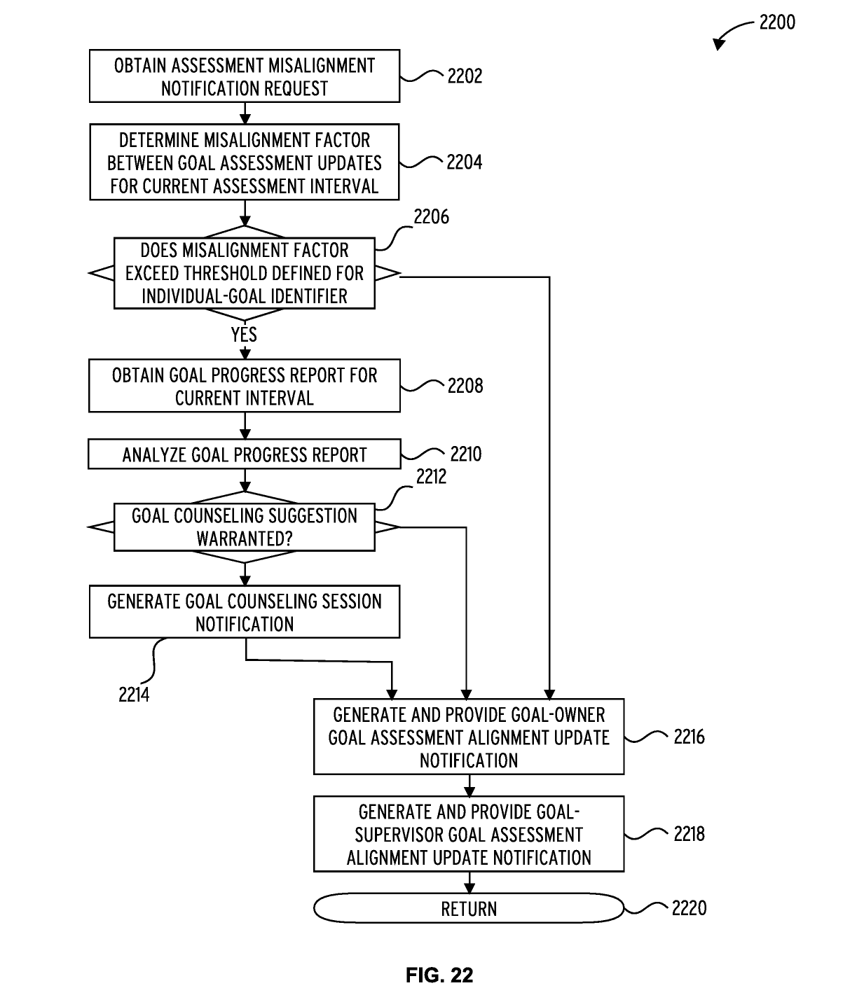

FIG. 22 illustrates an assessment misalignment notification sub-routine 2200 such as may be performed by remote goal alignment tracking service 1414 operating on remote goal alignment tracking server 1400 in furtherance of a goal alignment tracking provider. Assessment misalignment notification sub-routine 2200 may be performed in response to an assessment misalignment notification request, for example obtained from goal progress assessment update routine 1900.

In block 2202, assessment misalignment notification sub-routine 2200 obtains an assessment misalignment notification request. The assessment misalignment notification request may include an individual-level goal identifier.

In block 2204, assessment misalignment notification sub-routine 2200 determines a misalignment factor between the goal assessment updates for the current assessment interval. As is shown in Table 1, the misalignment factor may have a one of two magnitude values: minor misalignment or severe misalignment, and one of two direction values: positive misalignment or negative misalignment.

TABLE 1

| | | Misalignment | Misalignment |
|---|---|---|---|
| Goal-Owner | Goal-Supervisor | Factor | Factor |
| Assessment | Assessment | Magnitude | Direction |
| Did not meet | Did not meet | N/A (neutral) | N/A (neutral) |
| expectations | expectations | | |
| Met expectations | Met expectations | N/A (neutral) | N/A (neutral) |
| Exceeded | Exceeded | N/A (neutral) | N/A (neutral0 |
| expectations | expectations | | |
| Did not meet | Met expectations | Minor | Positive |
| expectations | | | |
| Did not meet | Exceeded | Severe | Positive |
| expectations | expectations | | |
| Met expectations | Did not meet | Minor | Negative |
| | expectations | | |
| Met expectations | Exceeded | Minor | Positive |
| | expectations | | |
| Exceeded | Did not meet | Severe | Negative |
| expectations | expectations | | |
| Exceeded | Met expectations | Minor | Negative |
| expectations | | | |

At decision block 2206, if the misalignment factor exceeds a misalignment threshold associated with the individual-level goal identifier, then assessment misalignment notification sub-routine 2200 may proceed to block 2208; otherwise assessment misalignment notification sub-routine 2200 may proceed to block 2216. For example, if direction value of the misalignment factor is negative, a magnitude factor magnitude value of either minor or severe misalignment may exceed the misalignment threshold associated with the individual-level goal identifier, while if the direction value of the misalignment factor is positive, only a severe misalignment factor may exceed the misalignment threshold associated with the individual-level goal identifier.

In block 2208, assessment misalignment notification sub-routine 2200 may obtain the goal progress report for the current interval, previously generated by goal progress review sub-routine 2300, e.g. via goal alignment tracking data store 1302.

In block 2210, assessment misalignment notification sub-routine 2200 may analyze the goal progress report to determine if the misalignment between the goal assessments for the current assessment interval and the data from the goal progress report indicates a goal counseling session would be beneficial for the goal-owner and/or the goal-supervisor.

At decision block 2212, if assessment misalignment notification sub-routine 2200 the analysis of block 2210 indicates a goal counseling session is warranted, then assessment misalignment notification sub-routine 2200 may proceed to block 2214; otherwise assessment misalignment notification sub-routine 2200 may proceed to block 2216.

In block 2214, assessment misalignment notification sub-routine 2200 generates a goal counseling session notification.

In block 2216, assessment misalignment notification sub-routine 2200 generates and provides a goal-owner assessment alignment update notification. If assessment misalignment notification sub-routine 2200 has previously determined a goal counseling session is warranted, the goal counseling session notification may be included in the goal-owner goal assessment alignment update notification.

In block 2218, assessment misalignment notification sub-routine 2200 generates and provides a goal-supervisor assessment alignment update notification. If assessment misalignment notification sub-routine 2200 has previously determined a goal counseling session is warranted, the goal counseling session notification will be included in the goal-supervisor goal assessment alignment update notification.

Assessment misalignment notification sub-routine 2200 ends at return block 2220.

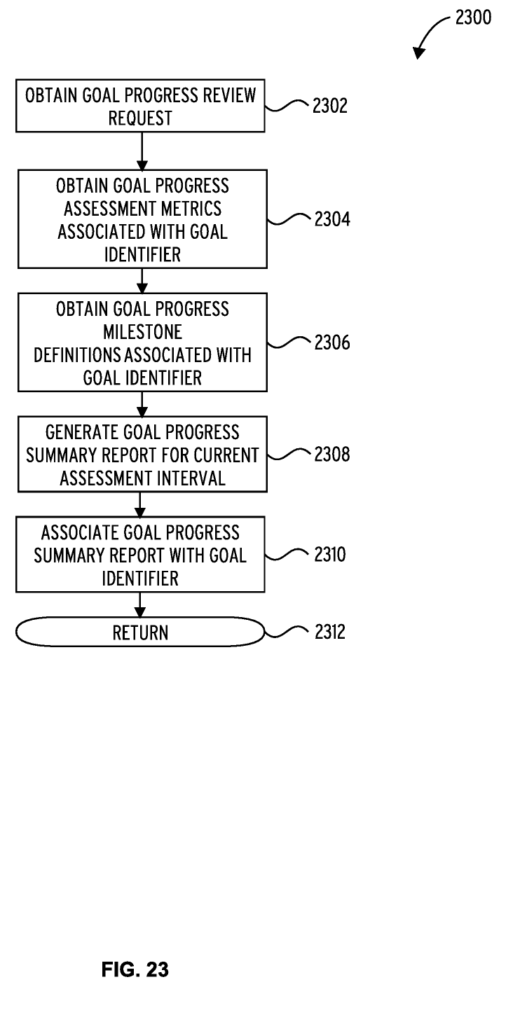

FIG. 23 illustrates a goal progress review sub-routine 2300 such as may be performed by remote goal alignment tracking service 1414 operating on remote goal alignment tracking server 1400 in furtherance of a goal alignment tracking provider. Goal progress review sub-routine 2300 may be performed in response to a goal progress review request, for example obtained from cumulative goal progress assessment sub-routine 2000.

In block 2302, goal progress review sub-routine 2300 obtains a goal progress review request. The goal progress review request may include a goal identifier, which may be an individual-level goal identifier or an organizational-level goal identifier.

In block 2304, goal progress review sub-routine 2300 obtains any goal progress assessment metrics associated with the goal identifier, e.g. from goal alignment tracking data store 1302. In block 2306, goal progress review sub-routine 2300 obtains any goal progress milestone definitions associated the the goal identifier.

In block 2308, goal progress review sub-routine 2300 generates a goal progress summary report for the current assessment interval, for example using data obtained in block 2302 and/or block 2304.

In block 2310, goal progress review sub-routine 2300 associates the goal progress summary report with the goal identifier, e.g. in goal alignment tracking data store 1302.

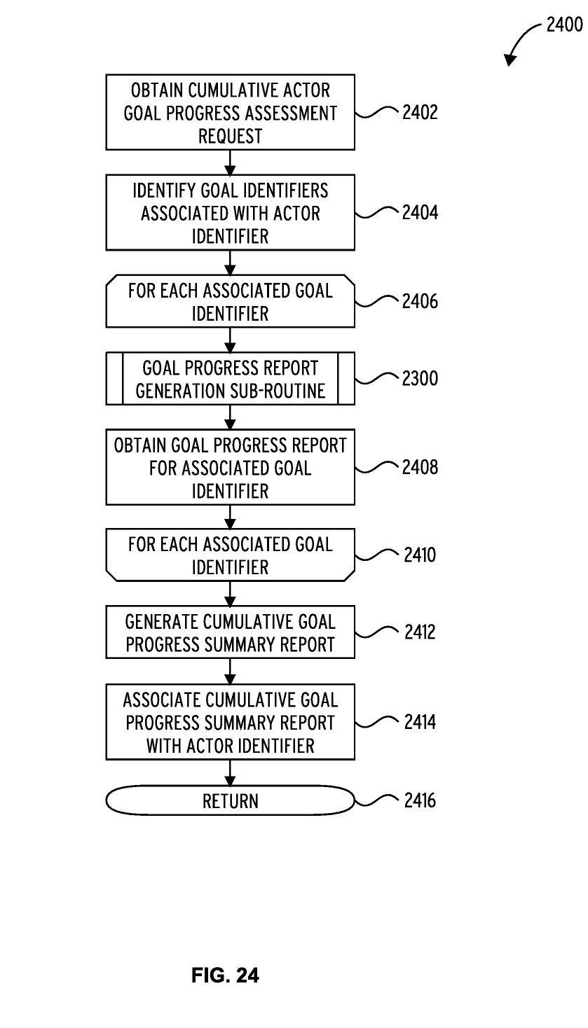

FIG. 24 illustrates a cumulative actor goal progress assessment routine 2400 such as may be performed by remote goal alignment tracking service 1414 operating on remote goal alignment tracking server 1400 in furtherance of a goal alignment tracking provider. Cumulative actor goal progress assessment routine 2400 may be performed in response to a goal progress review request, for example obtained from remote front-end service 1420.

In block 2402, cumulative actor goal progress assessment routine 2400 obtains a cumulative actor goal progress assessment request. The cumulative actor goal progress assessment request may include an actor identifier associated with one or more individual-level organizational-level goal identifiers and/or organizational-level goal identifiers.

In block 2404, cumulative actor goal progress assessment routine 2400 may identify one or more individual-level organizational-level goal identifiers and/or organizational-level goal identifiers associated with the actor identifier, e.g. as any of a goal-owner identifier, a goal-supporter identifier, or a goal-supervisor identifier.

At opening loop block 2406, cumulative actor goal progress assessment routine 2400 processes each associated goal identifier in turn.

At sub-routine block 2400, cumulative actor goal progress assessment routine 2400 calls goal progress review sub-routine 2300, described above. Goal progress review sub-routine 2300 creates a goal progress report and associates the goal progress report with the associated goal identifier, e.g. via goal alignment tracking data store 1302.

In block 2408, cumulative actor goal progress assessment routine 2400 obtains the goal progress report for the associated goal identifier created by goal progress review sub-routine 2300, e.g. via goal alignment tracking data store 1302.

At closing loop block 2410, cumulative actor goal progress assessment routine 2400 iterates back to opening loop block 2406 to process the next associated goal identifier, if any.

In block 2412, cumulative actor goal progress assessment routine 2400 generates a cumulative goal progress summary report, e.g. using data from some or all of the goal progress reports obtained in block 2408.

In block 2414, cumulative actor goal progress assessment routine 2400 associates the cumulative goal progress summary report generated in block 2412 with the actor identifier, e.g. via goal alignment tracking data store 1302.

Cumulative actor goal progress assessment routine 2400 ends at termination block 2416.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A method for facilitating organizational goal alignment comprising:
(a) obtaining an organizational-level goal definition request;
(b) associating said organizational-level goal definition request with an organizational-level goal identifier;
(c) obtaining a plurality of individual-level goal definition requests, each of said plurality of individual-level goal definition requests including said organizational-level goal identifier, an individual goal statement, a responding individual performer identifier, and a responding supervisor identifier;
(d) associating each of said plurality of individual-level goal definition requests with an individual-level goal definition indexed by an individual-level goal identifier; and
(c) performing sub-steps i-v for an individual-level goal definition request of said plurality of individual-level goal definition requests:
(i) obtaining a first subjective goal assessment notification said first subjective goal assessment notification being associated with a current assessment interval and including a corresponding individual-level goal definition identifier, a first responder identifier, and a first subjective progress rating, said first responder identifier corresponding to a responding individual perform identifier associated with said corresponding individual-level goal definition identifier;
(ii) obtaining a second subjective goal assessment notification, said second subjective goal assessment notification being associated with said current assessment interval and including said corresponding individual-level goal definition identifier, a second responder identifier, and a second subjective progress rating, said second responder identifier corresponding to a responding supervisor identifier associated with said corresponding individual-level goal definition;
(iii) comparing said first subjective progress rating to said second subjective progress rating to determine a current indication of alignment;
(iv) associating said first subjective goal assessment notification, said second subjective goal assessment notification, and said current indication of alignment with said corresponding individual-level goal definition identifier;
(v) providing a first goal assessment summary including said first subjective progress rating and said current indication of alignment to said responding supervisor identifier; and
(vi) providing a second goal assessment summary including said second subjective progress rating and said current indication of alignment to said responding individual performer identifier.

2. The method of claim 1, wherein said first subjective goal assessment notification and said second subjective goal assessment notification must be obtained before said first goal assessment summary is provided to said responding supervisor identifier.

3. The method of claim 1 the method further comprising repeating step cover a plurality of assessment intervals and wherein step (iii) also includes comparing said current indication of alignment to at least one previously determined indication of alignment to determine a current progress alignment trend value and said first goal assessment summary and said second goal assessment summary each include said current progress alignment trend value.

4. The method of claim 1, wherein said first subjective goal assessment notification includes a first progress assessment statement, said second subjective goal assessment notification includes a second progress assessment statement, said first goal assessment summary includes said second progress assessment statement, and said second goal assessment summary includes said first progress assessment statement.

5. The method of claim 4, wherein said first subjective goal assessment notification and said second subjective goal assessment notification include a cumulative goal progress assessment summary.

6. The method of claim 1, wherein said first subjective progress rating and said second subjective progress rating each have a value selected from a set of three possible values, a first value of said set of three possible values corresponding to below expectations, a second value of said set of three possible values corresponding to meeting expectations, and a third value of said set of three possible values corresponding to exceeding expectations.

7. The method of claim 1, wherein said current indication of alignment has a magnitude component and a direction component; said magnitude component having a value selected from a set of three possible magnitude values, a first value of said set of three possible magnitude values corresponding to alignment, said second value of said set of three possible magnitude values corresponding to misalignment, and said third value of said set of three possible magnitude values corresponding to severe misalignment; and said direction component having a value selected from a set of three possible direction values, a first value of said set of three possible direction values corresponding to negative misalignment, a second value of said set of three possible direction values corresponding to neutral alignment, and a third value of said set of three possible direction values corresponding to positive misalignment.

8. The method of claim 7, wherein step (iii) includes determining said magnitude component of said current indication of alignment has said third value and said direction component of said current indication of alignment and said first goal assessment summary includes a goal counseling session notification.

9. The method of claim 1, wherein:
said individual-level goal definition request includes a goal milestone definition;
said first subjective goal assessment notification includes goal progress metric data related to said goal milestone definition;
step (iii) includes obtaining requirement data related to said goal milestone definition, comparing said goal progress metric data to said requirement data; and determining a requirement related to said goal milestone definition has been met; and
said first goal assessment summary and said second goal assessment summary include a milestone completion notification.

10. The method of claim 1, wherein:
said individual-level goal definition request includes a related-goal identifier;
said first subjective goal assessment notification includes goal progress metric data, and
step (iii) includes obtaining requirement data related to a goal milestone definition associated with said related-goal identifier.

11. A system useful in facilitating organizational goal alignment, the system comprising:
a data store containing at least:
organizational-goal definition data associated with a client entity identifier;
individual-goal definition data associated with said client entity identifier; and
inventory data associated with said first user account associated with said client entity identifier; and
a computer processing unit;
a network interface in data communication with said computer processing unit and said data store; and
memory in data communication with said computer processing unit and containing executable instructions for causing said computer processing unit to perform a method comprising:
(a) obtaining an organizational-level goal definition request;
(b) associating said organizational-level goal definition request with an organizational-level goal identifier;
(c) obtaining a plurality of individual-level goal definition requests, each of said plurality of individual-level goal definition requests including said organizational-level goal identifier, an individual goal statement, a responding individual performer identifier, and a responding supervisor identifier;
(d) associating each of said plurality of individual-level goal definition requests with an individual-level goal definition indexed by an individual-level goal identifier; and
(c) performing sub-steps i-v for an individual-level goal definition request of said plurality of individual-level goal definition requests:
(i) obtaining a first subjective goal assessment notification said first subjective goal assessment notification being associated with a current assessment interval and including a corresponding individual-level goal definition identifier, a first responder identifier, and a first subjective progress rating, said first responder identifier corresponding to a responding individual perform identifier associated with said corresponding individual-level goal definition identifier;
(ii) obtaining a second subjective goal assessment notification, said second subjective goal assessment notification being associated with said current assessment interval and including said corresponding individual-level goal definition identifier, a second responder identifier, and a second subjective progress rating, said second responder identifier corresponding to a responding supervisor identifier associated with said corresponding individual-level goal definition;
(iii) comparing said first subjective progress rating to said second subjective progress rating to determine a current indication of alignment;
(iv) associating said first subjective goal assessment notification, said second subjective goal assessment notification, and said current indication of alignment with said corresponding individual-level goal definition identifier;
(v) providing a first goal assessment summary including said first subjective progress rating and said current indication of alignment to said responding supervisor identifier; and
(vi) providing a second goal assessment summary including said second subjective progress rating and said current indication of alignment to said responding individual performer identifier.
